(19) United States
(12) Patent Application Publication
(10) Pub. No.: US 2025/0317715 A1
(43) Pub. Date: Oct. 9, 2025

(54) SENSING METHOD, SENSING APPARATUS, COMMUNICATION DEVICE, AND STORAGE MEDIUM

(71) Applicant: VIVO MOBILE COMMUNICATION CO., LTD., Guangdong (CN)

(72) Inventors: Jianzhi LI, Guangdong (CN); Dajie JIANG, Guangdong (CN); Jian YAO, Guangdong (CN)

(73) Assignee: VIVO MOBILE COMMUNICATION CO., LTD., Guangdong (CN)

(21) Appl. No.: 19/243,248

(22) Filed: Jun. 19, 2025

Related U.S. Application Data
(63) Continuation of application No. PCT/CN2023/139723, filed on Dec. 19, 2023.

(30) Foreign Application Priority Data
Dec. 21, 2022 (CN) 202211651981.7

(51) Int. Cl. H04W 4/38; H04B 7/06; H04W 72/044; H04W 72/0446; H04W 72/51

(52) U.S. Cl. CPC H04W 4/38; H04B 7/0626; H04W 72/0446; H04W 72/0473; H04W 72/51

(57) ABSTRACT

This application discloses a sensing method, a sensing apparatus, a communication device, and a storage medium, and pertains to the field of communication technologies. The sensing method in embodiments of this application includes: sending, by a first device, first information, where the first information is random phase-related information of the first device, and the first device is a terminal; receiving, by the first device, sensing configuration information, where the sensing configuration information is determined based on the first information; and sending, by the first device, a first signal to a second device based on the sensing configuration information, where the first signal is a signal related to a sensing service or an integrated sensing and communication service, and the second device is a terminal or a network side device.

### CROSS-REFERENCE TO RELATED APPLICATIONS

This application is a continuation application of PCT Application No. PCT/CN2023/139723 filed on Dec. 19, 2023, which claims priority to Chinese Patent Application No. 202211651981.7, filed in China on Dec. 21, 2022, disclosures of which are incorporated herein by reference in their entireties.

### TECHNICAL FIELD

This application pertains to the field of sensing and communication technologies, and specifically relates to a sensing method, a sensing apparatus, a communication device, and a storage medium.

### BACKGROUND

In an integrated sensing and communication (ISAC) technology, it is particularly important to obtain accurate measurement information, and non-ideal factors of a component and a hardware circuit affect measurement accuracy. Currently, when channel estimation is performed based on a reference signal (such as a sounding reference signal (SRS)), phases of uplink channel estimation on a base station side are discontinuous in terms of time, that is, there is a random phase offset between channel estimations at different uplink moments. If user equipment (UE, or terminal) has a plurality of radio frequency channels, different random phases are introduced on different radio frequency channels. The random phase may introduce a sensing error, and even a sensing service cannot be performed. It can be learned that in a related technology, a problem of relatively poor sensing performance is caused due to a random phase of a terminal.

### SUMMARY

According to a first aspect, a sensing method is provided, and the method includes:
sending, by a first device, first information, where the first information is random phase-related information of the first device, and the first device is a terminal;
receiving, by the first device, sensing configuration information, where the sensing configuration information is determined based on the first information; and
sending, by the first device, a first signal to a second device based on the sensing configuration information, where the first signal is a signal related to a sensing service or an integrated sensing and communication service, and the second device is a terminal or a network side device.

According to a second aspect, a sensing apparatus is provided, and is applied to a first device, where the first device is a terminal, and the apparatus includes:
a first sending module, configured to send first information, where the first information is random phase-related information of the first device, and the first device is a terminal;
a first receiving module, configured to receive sensing configuration information, where the sensing configuration information is determined based on the first information; and
a second sending module, configured to send a first signal to a second device based on the sensing configuration information, where the first signal is a signal related to a sensing service or an integrated sensing and communication service, and the second device is a terminal or a network side device.

According to a third aspect, a sensing method is provided, and the method includes:
receiving, by a second device, first information, where the first information is random phase-related information of a first device, the first device is a terminal, and the second device is a terminal or a network side device;
sending, by the second device, sensing configuration information to the first device based on the first information; and
receiving, by the second device, a first signal from the first device, where the first signal is a signal that is determined based on the sensing configuration information and that is related to a sensing service or an integrated sensing and communication service.

According to a fourth aspect, a sensing apparatus is provided, and is applied to a second device, where the second device is a terminal or a network side device, and the apparatus includes:
a first receiving module, configured to receive first information, where the first information is random phase-related information of a first device, the first device is a terminal, and the second device is a terminal or a network side device;
a first sending module, configured to send sensing configuration information to the first device based on the first information; and
a second receiving module, configured to receive a first signal from the first device, where the first signal is a signal that is determined based on the sensing configuration information and that is related to a sensing service or an integrated sensing and communication service.

According to a fifth aspect, a sensing method is provided, where the method includes:
receiving, by a third device, sensing configuration information from a second device, where the sensing configuration information is determined based on random phase-related information of a first device, the first device is a terminal, the second device is another terminal, and the third device is a network side device;
receiving, by the third device, at least one of a first signal and a second signal, where the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service; and
sending, by the third device, third information to the second device based on the sensing configuration information and the at least one of the first signal and the second signal, where the third information includes a random phase measurement value.

According to a sixth aspect, a sensing apparatus is provided, and is applied to a third device, where the third device is a network side device, and the apparatus includes:
a first receiving module, configured to receive first information, where the first information is random phase-related information of a first device, the first device is a terminal, and the second device is a terminal or a network side device;
a first sending module, configured to send sensing configuration information to the first device based on the first information; and
a second receiving module, configured to receive a first signal from the first device, where the first signal is a signal that is determined based on the sensing configuration information and that is related to a sensing service or an integrated sensing and communication service.

According to a seventh aspect, a communication device is provided. The communication device includes a processor and a memory, the memory stores a program or instructions capable of running on the processor, and when the program or the instructions are executed by the processor, the steps of the method according to the first aspect are implemented, the steps of the method according to the third aspect are implemented, or the steps of the method according to the fifth aspect are implemented.

According to an eighth aspect, a first device is provided. The first device is a terminal, and the first device includes a processor and a communication interface. The communication interface is configured to: send first information, where the first information is random phase-related information of the first device; receive sensing configuration information, where the sensing configuration information is determined based on the first information; and send a first signal to a second device based on the sensing configuration information, where the first signal is a signal related to a sensing service or an integrated sensing and communication service, and the second device is a terminal or a network side device.

According to a ninth aspect, a second device is provided. The second device is a terminal or a network side device, and the second device includes a processor and a communication interface. The communication interface is configured to: receive first information, where the first information is random phase-related information of a first device, and the first device is a terminal; send sensing configuration information to the first device based on the first information; and receive a first signal from the first device, where the first signal is a signal that is determined based on the sensing configuration information and that is related to a sensing service or an integrated sensing and communication service.

According to a tenth aspect, a third device is provided. The third device is a network side device, and the third device includes a processor and a communication interface. The communication interface is configured to: receive sensing configuration information from a second device, where the sensing configuration information is determined based on random phase-related information of a first device, the first device is a terminal, and the second device is another terminal; receive at least one of a first signal and a second signal, where the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service; and send third information to the second device based on the sensing configuration information and the at least one of the first signal and the second signal, where the third information includes a random phase measurement value.

According to an eleventh aspect, a communication system is provided, including a first device and a second device. The first device may be configured to perform the steps of the sensing method according to the first aspect, and the second device may be configured to perform the steps of the sensing method according to the third aspect.

According to a twelfth aspect, a communication system is provided, including a first device, a second device, and a third device. The first device may be configured to perform the steps of the sensing method according to the first aspect, the second device may be configured to perform the steps of the sensing method according to the third aspect, and the third device may be configured to perform the steps of the sensing method according to the fifth aspect.

According to a thirteenth aspect, a readable storage medium is provided. The readable storage medium stores a program or instructions, and when the program or the instructions are executed by a processor, the steps of the method according to the first aspect are implemented, the steps of the method according to the third aspect are implemented, or the steps of the method according to the fifth aspect are implemented.

According to a fourteenth aspect, a chip is provided. The chip includes a processor and a communication interface, the communication interface is coupled to the processor, and the processor is configured to run a program or instructions to implement the steps of the method according to the first aspect, the steps of the method according to the third aspect, or the steps of the method according to the fifth aspect.

According to a fifteenth aspect, a computer program/program product is provided. The computer program/program product is stored in a storage medium, and the computer program/program product is executed by at least one processor to implement the steps of the method according to the first aspect, the steps of the method according to the third aspect, or the steps of the method according to the fifth aspect.

### BRIEF DESCRIPTION OF DRAWINGS

FIG. 1 is a schematic diagram of a network structure applicable to an embodiment of this application;

FIG. 2 is a schematic diagram of six basic sensing manners;

FIG. 3 is a flowchart of a sensing method according to an embodiment of this application;

FIG. 4 is a flowchart of another sensing method according to an embodiment of this application;

FIG. 5 is a schematic diagram of configurations of a random phase measurement signal at different moments in a random phase estimation method according to an embodiment of this application;

FIG. 6 is a schematic diagram of extracting a reference path parameter at different moments in a random phase estimation method according to an embodiment of this application;

FIG. 7 is a schematic diagram of random phase deflection at different moments in a random phase estimation method according to an embodiment of this application;

FIG. 8 is a schematic diagram of random phases of different antenna ports in a method for estimating random phases of different antenna ports according to an embodiment of this application;

FIG. 9 is a schematic diagram of extracting a reference path parameter in a method for estimating random phases of different antenna ports according to an embodiment of this application;

FIG. 10 is a schematic diagram of random phase deflection in a method for estimating random phases of different antenna ports according to an embodiment of this application;

FIG. 11 is a flowchart of another sensing method according to an embodiment of this application;

FIG. 12a is an overall flowchart of a sensing method according to an embodiment of this application;

FIG. 12b is an overall flowchart of another sensing method according to an embodiment of this application;

FIG. 13a is an overall flowchart of another sensing method according to an embodiment of this application;

FIG. 13b is an overall flowchart of another sensing method according to an embodiment of this application;

FIG. 14 is a structural diagram of a sensing apparatus according to an embodiment of this application;

FIG. 15 is a structural diagram of another sensing apparatus according to an embodiment of this application;

FIG. 16 is a structural diagram of another sensing apparatus according to an embodiment of this application;

FIG. 17 is a structural diagram of a communication device according to an embodiment of this application;

FIG. 18 is a structural diagram of a terminal according to an embodiment of this application;

FIG. 19 is a structural diagram of a network side device according to an embodiment of this application; and

FIG. 20 is a structural diagram of another network side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. A new radio (NR) system is described for illustrative purposes in the following descriptions, and NR terms are used in most of the following descriptions. However, these technologies are also applicable to applications such as a 6th generation (6G) communication system other than NR system applications.

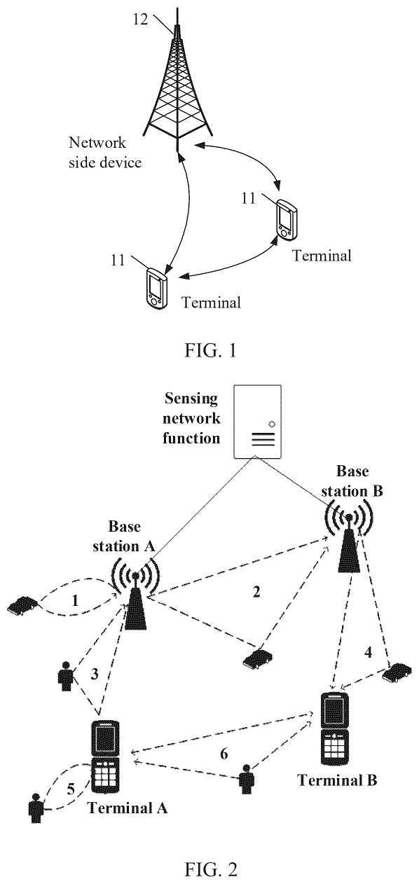

FIG. 1 is a block diagram of a wireless communication system applicable to an embodiment of this application. The wireless communication system includes a terminal 11 and a network side device 12. The terminal 11 may be a mobile phone, a tablet personal computer, a laptop computer that is alternatively referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network side device 12 may include an access network device or a core network node, and the access network device may also be referred to as a radio access network device, a radio access network (RAN), a radio access network function, or a radio access network unit. The access network device may include a base station, a wireless local area network (WLAN) access point, a wireless fidelity (WiFi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another suitable term in the field. The base station is not limited to a specific technical term, provided that a same technical effect is achieved. It needs to be noted that, in this embodiment of this application, descriptions are provided only by using a base station in an NR system as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in this embodiment of this application, only a core network node in the NR system is used as an example for description, and a specific type of the core network node is not limited.

This application relates to an integrated sensing and communication (“integrated sensing & communication” for short) technology, and related descriptions of the integrated sensing and communication technology are first provided below.

Wireless communication and radar sensing (Communication&Sensing, C&S) have been developing in parallel but with a limited intersection. Wireless communication and radar sensing share many commonalities in terms of a signal processing algorithm, a device, and a system architecture to some extent. In recent years, a conventional radar is developing towards more general-purpose wireless sensing. In wireless sensing, information may be broadly retrieved from a received radio signal. For wireless sensing related to sensing of a target location, a target signal reflection delay, an angle of arrival, an angle of departure, Doppler, and other dynamic parameters may be estimated by using a common signal processing method. A physical feature of a target may be sensed by measuring an inherent signal pattern of a device/object/activity. The two sensing manners may be respectively referred to as sensing parameter estimation and pattern recognition. In this sense, wireless sensing refers to more general-purpose sensing technologies and applications using radio signals.

Integrated sensing and communication (ISAC) has the potential to integrate wireless sensing into large-scale mobile networks, which are referred to as perceptive mobile networks (PMNs) herein. The perceptive mobile networks can provide both communication and wireless sensing services, and are expected to become a ubiquitous wireless sensing solution because of relatively extensive broadband coverage and robust infrastructure of the perceptive mobile networks. The perceptive mobile networks may be widely applied to communication and sensing in the fields of transportation, communication, energy, precision agriculture, and security. The perceptive mobile networks may further provide complementary sensing capabilities to existing sensor networks, have unique day and night operation functions, and can penetrate fog, leaves, and even solid objects. Some common sensing services are shown in Table 1 below:

TABLE 1

| Sensing | Sensing real- | | |
|---|---|---|---|
| physical | time | | |
| range | requirement | Sensing function | Application uses |
| Large | Medium | Weather, air quality, and the | Meteorology, agriculture, and |
| | | like | life services |
| Large | Medium | Traffic flow (roads) and | Smart city, smart |
| | | crowd flow (subway | transportation, and commercial |
| | | stations) | services |
| Large | Medium | Animal activity and | Animal husbandry, ecological |
| | | migration, and the like | environment protection, and |
| | | | the like |
| Large | High | Target tracking, ranging, | Many application scenarios of |
| | | speed measurement, and | a conventional radar, V2X, |
| | | angle measurement | and the like |
| Large | Low | Three-dimensional map | Navigation and smart city |
| | | construction | |
| Small | High | Action and posture | Smart interaction of |
| | | recognition | smartphones, games, and smart |
| | | | home |
| Small | High | Heartbeat/breathing and the | Health monitoring and medical |
| | | like | care |
| Small | Medium | Imaging | Security check and logistics |
| Small | Low | Material | Construction, manufacturing, |
| | | | exploration, and the like |

There are six basic sensing manners based on different sensing signal sending nodes and receiving nodes. As shown in FIG. 2, the following sensing manners are specifically included:
(1) Self-sending and self-receiving sensing of a base station (which is also referred to as “a network side device”). In this sensing manner, a base station A sends a sensing signal, and performs sensing measurement by receiving an echo of the sensing signal.
(2) Air interface sensing between base stations. In this sensing manner, a base station B performs sensing measurement by receiving a sensing signal sent by a base station A.
(3) Uplink air interface sensing. In this sensing manner, a base station A performs sensing measurement by receiving a sensing signal sent by a terminal A.
(4) Downlink air interface sensing. In this sensing manner, a terminal B performs sensing measurement by receiving a sensing signal sent by a base station B.
(5) Self-sending and self-receiving sensing of a terminal. In this sensing manner, a terminal A sends a sensing signal, and performs sensing measurement by receiving an echo of the sensing signal.
(6) Sidelink sensing between terminals. In this sensing manner, a terminal B performs sensing measurement by receiving a sensing signal sent by a terminal A.

It should be noted that for each sensing manner in FIG. 2, one sensing signal sending node and one sensing signal receiving node are used as an example. In an actual system, one or more different sensing manners may be selected based on different sensing use cases and different sensing requirements, and there may be one or more sending nodes and one or more receiving nodes for each sensing manner.

For related introductions of integrated sensing and communication, reference may be made to the following reference documents.
[1] Rahman, Md Lushanur, et al. “Enabling joint communication and radio sensing in mobile networks-a survey.” arXiv preprint arXiv: 2006.07559 (2020).

In integrated sensing and communication, it is particularly important to obtain accurate measurement information, and non-ideal factors of a component and a hardware circuit significantly affect measurement accuracy. A sensing manner of sending and receiving between a base station and a terminal is used as an example. Extracting channel state information (CSI) to perform sensing is a main implementation of integrated sensing and communication. Therefore, it is particularly important to obtain a sensing channel with relatively good quality, and a CSI measurement error caused by some non-ideal factors significantly affects sensing accuracy. For non-ideal factors related to sensing, reference may be made to the following reference documents:
[2] Zhuo, Y., Zhu, H., Xue, H., & Chang, S. (2017 May). Perceiving accurate CSI phases with commodity WiFi devices. In IEEE INFOCOM 2017-IEEE Conference on Computer Communications (pp. 1-9). IEEE.
[3] Zhang, J. A., Wu, K., Huang, X., Guo, Y. J., Zhang, D., & Heath Jr, R. W. (2022). Integration of Radar Sensing into Communications with Asynchronous Transceivers. arXiv preprint arXiv: 2203.16043.
[4] Tadayon, N., Rahman, M. T., Han, S., Valaee, S., & Yu, W. (2019). Decimeter ranging with channel state information. IEEE Transactions on Wireless Communications, 18 (7), 3453-3468.]

The reference document [2] summarizes impact exerted by a receive end on CSI, including:
(1) Power amplifier uncertainty (PAU) or uncertainty of received power of a signal. Because a component such as a low noise amplifier (LNA) or a programmable gain amplifier (PGA) is not ideal, actual gain adjustment does not match an expectation, and consequently, a CSI amplitude obtained through measurement is inaccurate.
(2) IQ path imbalance. Due to limitations of performance of I-path and Q-path components, the following problems are caused: a phase difference of local-frequency signals cannot be ensured to be strictly 90°, there is a difference between gains of two paths of signals, and a direct-current offset exists. Consequently, orthogonality of a baseband signal is damaged and CSI is deteriorated.
(3) Time-frequency synchronization deviation. Factors such as a deviation between clocks of a receive end and a transmit end and non-ideal synchronization lead to problems such as a carrier frequency offset, a sampling frequency offset, and a symbol timing offset, which may affect accuracy of speed estimation or lead to fuzzy ranging. In the document [3], the authors summarize methods such as sharing a reference clock, multi-antenna correlation in a single station, and multi-station joint cancellation of timing errors, and describe that impact exerted by a clock deviation on sensing may be dealt with by improving a global positioning system (GPS) clock, relaxing a single-node sensing requirement, multi-node measurement, and target correlation.
(4) Antenna/array amplitude and phase error. This includes: When sensing is performed by using beamforming, due to beamforming amplitude and phase errors, a formed beam shape (a beam gain, a beam width, and a sidelobe level) is inconsistent with an actual situation, and when sensing is performed based on beamformed channel information, accuracy is reduced, and angle and reflection power estimation errors are caused, and even a false detection is caused. In addition, a beam switching delay increases impact exerted by interference and noise on a sensing result. The document [4] summarizes impact exerted by a transmit end on CSI, and mainly includes the following: due to processing such as windowing, precoding, or beamforming that is unknown to a receive end, the receive end cannot obtain real channel information.
(5) Random phase in time domain (referred to as “random phase” for short below). The random phase is from a change in a state of at least one of a transmitter antenna, a radio frequency module (including various components connected to a radio frequency channel), a digital processing module, and a clock module in a signal sending and receiving process, that is, transition from one state to another state, for example, transition from an on state to an off state, or transition from an off state to an on state. If a device has more than one set of transmitters, each set of transmitters may produce an independent random phase. If each set of transmitters are connected to at least one antenna, antennas/antenna sub-arrays connected to different transmitters have different random phases. Within bandwidth of a transmit signal, random phases are generally consistent, but random phase values generated at different moments are different, and are presented as random distribution in a specific range of radians.

Currently, when channel estimation is performed based on a reference signal (such as an SRS), phases of uplink channel estimation on a base station side are discontinuous in terms of time, that is, there is a random phase offset between channel estimation at different uplink moments. If a terminal has more than one radio frequency channel, different random phases are introduced on different radio frequency channels. The random phase hardly affects communication performance, but introduces an uplink sensing error, and even a sensing service cannot be performed.

In view of this, in embodiments of this application, a first device provides random phase-related information of the first device, and the first device receives sensing configuration information determined by another related device based on the random phase-related information, so that the first device can send a first signal based on the sensing configuration information, to resolve impact exerted by a random phase on sensing performance (or integrated sensing and communication performance), thereby improving the sensing performance.

In the embodiments of this application, the first signal may be a signal related to a sensing service or an integrated sensing and communication service. The first signal is explained below as follows:

The first signal is a sensing signal or an integrated sensing and communication signal, that is, a sensing service may be supported through reception of the signal. For example, a sensing measurement quantity or a sensing result may be obtained through reception of the signal.

The first signal may be a signal that does not include transmission information, such as an existing LTE/NR synchronization and reference signal, including a synchronization signal and physical broadcast channel block (SSB) signal, a channel state information-reference signal (CSI-RS), a demodulation reference signal (DMRS), an SRS, a positioning reference signal (PRS), a phase tracking reference signal (PTRS), and the like; or the first signal may be a single-frequency continuous wave (CW), a frequency modulated continuous wave (FMCW), an ultra-wideband Gaussian pulse, or the like that is frequently used by a radar; or the first signal may be a newly designed dedicated signal, and has a good correlation characteristic and a low peak-to-average power ratio, or a newly designed integrated sensing and communication signal that carries specific information and has relatively good sensing performance at the same time. For example, the new signal is formed by splicing/combining/superimposing at least one dedicated sensing signal/reference signal and at least one communication signal in time domain and/or frequency domain.

The embodiments of this application relate to interaction between a plurality of devices. The plurality of devices may include devices such as a first device, a second device, a third device, and a reference node. The first device may be understood as a device that sends a sensing signal, that is, a device that sends a first signal or a sender of the sensing signal, and the first device is a terminal. The second device may be understood as a device that receives the sensing signal, that is, a device that receives a first signal or a receiver of the sensing signal, and the second device may be either a terminal or a network side device. When the second device is a network side device, the second device may be used as a receiver of the sensing signal, may be used as a device that determines sensing configuration information, may be used as a device that obtains a random phase measurement value, or may be used as a computing node of a sensing measurement quantity measurement value (or a sensing result). When the second device is a terminal, the second device may be used as a receiver of the sensing signal, may be used as a device that determines sensing configuration information, or may be used as a computing node of a sensing measurement quantity measurement value (or a sensing result). When the second device is a terminal, the embodiments of this application further relate to a third device. The third device is a network side device, and may be used as a device that determines sensing configuration information, or may be used as a device for obtaining a random phase measurement value. The reference node may be understood as a node that may reflect the sensing signal in a sensing service or an integrated sensing and communication service, and the reference node may be, for example, a reconfigurable intelligent surface (RIS), a backscatter (BSC) tag, or the like. In addition, the embodiments of this application may further relate to a fourth device. The fourth device is a network side device, and may be used as a device that assists in determining a sender of the sensing signal and a receiver of the sensing signal. The third device and the fourth device may be different network side devices, or may be a same network side device. This is not limited in the embodiments of this application.

A sensing method, a sensing apparatus, a communication device, and a storage medium provided in the embodiments of this application are described in detail below with reference to the accompanying drawings by using some embodiments and application scenarios thereof.

An implementation related to a sensing method corresponding to a first device side is first described below.

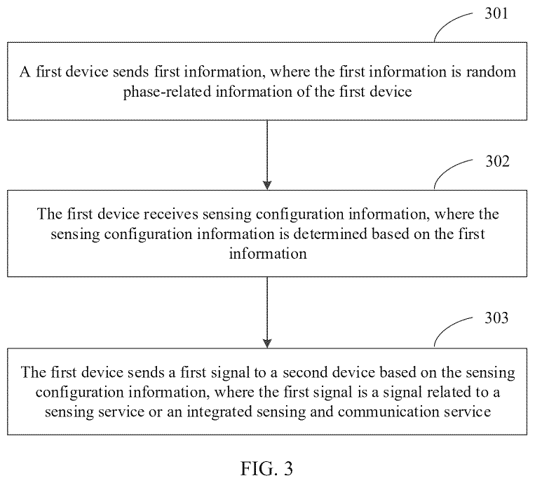

FIG. 3 is a flowchart of a sensing method according to an embodiment of this application. As shown in FIG. 3, the sensing method includes the following steps:
Step 301: A first device sends first information, where the first information is random phase-related information of the first device.
Step 302: The first device receives sensing configuration information, where the sensing configuration information is determined based on the first information.
Step 303: The first device sends a first signal to a second device based on the sensing configuration information, where the first signal is a signal related to a sensing service or an integrated sensing and communication service.

As described above, the first device is a device that sends a sensing signal, that is, a device that sends the first signal. The first device is a terminal, and the first device may have at least one antenna port. The second device is a device that receives the sensing signal, that is, a device that receives the first signal. The second device may be a terminal or a network side device. When the second device is a terminal, the first device and the second device are different terminals.

In step 301, that the first device sends the first information may include: The first device sends the first information to the first device and/or a third device.

The first information may include at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

The random phase information may include a random phase value and/or a random phase value range.

A function of sending the first information by the first device includes at least one of the following:

A first function is to indicate random phase information of an antenna port of the first device, so that the device that receives the first signal and/or a computing node calibrate/calibrates a result based on the random phase information, thereby eliminating impact exerted by a random phase on a sensing measurement quantity measurement value (or a sensing result).

A second function is to indicate information about antenna ports with a same random phase or different random phases in the antenna ports of the first device, so that the device that receives the first signal and/or the computing node determine/determines a transmit antenna port of the first device with reference to a multiple-input multiple-output (MIMO) sensing-related sensing requirement or sensing quality of service (QOS), and finally obtains an accurate MIMO (or multi-port) sensing measurement quantity measurement value (or a sensing result).

In this embodiment of this application, the first device provides the random phase-related information of the first device, and the first device receives sensing configuration information determined by another related device based on the random phase-related information, so that the first device can send a sensing signal based on the sensing configuration information. Through the foregoing process, impact exerted by a random phase on sensing performance can be resolved, so that the sensing performance can be improved.

In some embodiments, the first information includes at least one of the following (1) to (11):
(1) A random phase parameter of at least one antenna port of the first device.

Optionally, the random phase parameter includes at least one of a random phase value and a random phase value range.
(2) A variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior.

Optionally, between the first sending behavior and the second sending behavior, the first device has performed receiving behavior at least once, or to save power, the first device performs behavior of disabling a transmitting module, or the first device neither performs receiving behavior nor performs behavior of disabling a transmitting module.

For example, the variation parameter of the first random phase parameter of the at least one antenna port of the first device relative to the second random phase parameter may be a random phase value difference of the at least one antenna port before and after uplink-downlink switching of the first device, that is, a difference obtained by subtracting a random phase value existing before uplink-downlink switching from a random phase value obtained after uplink-downlink switching, or a difference obtained by subtracting a random phase value obtained after uplink-downlink switching from a random phase value existing before uplink-downlink switching.
(3) A variation parameter of a random phase parameter of at least one antenna port of the first device relative to a random phase parameter of a preset reference port.

For example, the variation parameter of the random phase parameter of the at least one antenna port of the first device relative to the random phase parameter of the preset reference port may be a difference between a random phase value of the at least one first port of the first device and a random phase value of the reference port, where the reference port may be any antenna port of the first device, and the first port is an antenna port that is in the first device and that is different from the reference port.
(4) Indication information of at least two antenna ports with a same random phase in the antenna ports of the first device.

For example, the indication information of the at least two antenna ports with the same random phase in the antenna ports of the first device may be indexes of the at least two antenna ports with the same random phase of the first device.
(5) Information about a mapping relationship between a physical antenna and at least two antenna ports with a same random phase in the antenna ports of the first device.

For example, the information about the mapping relationship between a physical antenna and at least two antenna ports with a same random phase in the antenna ports of the first device may be a correspondence between an index of the physical antenna and indexes of the at least two antenna ports with the same random phase of the first device.
(6) Information about a physical antenna to which at least two antenna ports with a same random phase in the antenna ports of the first device are mapped.

Optionally, the information about the physical antenna to which the at least two antenna ports with the same random phase in the antenna ports of the first device are mapped includes at least one of the following:
location information of the physical antenna, that is, location information of the physical antenna relative to a specific local reference point on an antenna array of the first device, where the location information may be represented by Cartesian coordinates (x, y, z) or spherical coordinates (ρ, φ, θ), and the local reference point may be any physical antenna location of the antenna array of the first device, or a physical center location of an antenna panel of the first device;
orientation information of the physical antenna, where the orientation information may be represented by spherical coordinates (φ, θ); and
a 2D or 3D radiation pattern of the physical antenna.
(7) Port quantity information of at least one group of antenna ports with a same random phase in the antenna ports of the first device.

For example, the foregoing port quantity information is a port quantity.
(8) Indication information of whether some or all antenna ports of the first device have a same random phase or different random phases.

For example, indication information of whether random phases are the same or different may be indicated by using a bitmap. For example, “0000” indicates that random phases of four ports of a terminal are different, “0110” indicates that random phases of a port 1 and a port 2 are the same and random phases of a port 0 and a port 3 are different, and “1111” indicates that the random phases of the four ports are the same.
(9) Antenna switching manner indication information of the first device.

For example, the antenna switching manner indication information may include 1T1R, 1T2R, 1T4R, 1T6R, 1T8R, 2T2R, 2T4R, 2T6R, 2T8R, 4T4R, and 4T8R, and may be represented as mTnR, n≥1, m≥1 For example, 2T4R indicates that in a same uplink slot, a quantity of transmit antennas of the first device is 2, and in a same downlink slot, a quantity of receive antennas of the first device is 4. Antenna switching as defined in the 3rd Generation Partnership Project (3GPP) technical specification (TS) 38.214 is described below as follows.

Section 6.2.1.2 of the 3GPP TS 38.214 provides detailed explanations of antenna switching (which is also referred to as antenna cycling) related to an uplink SRS. Considering antenna costs and an uplink rate requirement of the terminal, a quantity of transmit antennas of the terminal is generally less than a quantity of receive antennas. In addition, due to a limited transmit capability of the terminal, even if there are enough receive end antennas that can be used, the SRS cannot be sent on all receive end antennas at once. Therefore, the SRS needs to be sent on all receive antenna ports in an antenna switching manner. When usage in a higher-layer parameter “SRS-ResourceSet” of the terminal is configured as “antennaSwitching”, antenna switching capability information of the terminal may be configured by using a parameter supportedSRS-TxPortSwitch, and content of supportedSRS-TxPortSwitch may be one of the following: ‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘1t8r’ for 1T8R, ‘2t6r’ for 2T6R, ‘2t8r’ for 2T8R, ‘4t8r’ for 4T8R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2-t2r2-t1r4-t2r4’ for 1T=1R/1T2R/2T=2R/1T4R/2T4R, ‘t1r1’ for 1T=1R, ‘t2r2’ for 2T=2R, ‘t1r1-t2r2’ for 1T=1R/2T=2R, ‘t4r4’ for 4T=4R, and ‘t1r1-t2r2-t4r4’ for 1T=1R/2T=2R/4T=4R.

It is assumed that the terminal has m transmit antennas and n receive antennas, and m<n. When using the receive antennas to send the SRS, the terminal can send SRS resources on a maximum of m receive antennas at the same time. In the antenna switching manner, a total of n/m times are required to send all the SRS resources on all the receive antennas. For example, for ‘t2r4’ for 2T4R, a maximum of two SRS resource set resources may be configured for one terminal, and SRS resources transmitted on two different OFDM symbols may be configured for each SRS resource set. Each SRS resource corresponds to two SRS ports, and a terminal antenna port associated with two SRS ports of a second SRS resource in each SRS resource set is different from a terminal antenna port associated with two SRS ports of a first SRS resource in the SRS resource set.

For more explanations of options (that is, 1T1R/1T2R/1T4R/1T6R/1T8R/2T2R/2T4R/2T6R/2T8R/4T4R/4T8R) in a terminal antenna switching capability supportedSRS-TxPortSwitch, reference may be made to Section 6.2.1.2 of “3GPP TS 38.214 V17.0.0 Physical layer procedures for data”.
(10) Input/output parameter relationship information of a power amplifier (PA) of at least one antenna port of the first device.

Optionally, the input/output parameter relationship information includes at least one of the following:
information about an amplitude relationship between an input and an output, including an amplitude ratio of an input to an output of the PA and an amplitude relationship curve of an input to an output; and
information about a phase relationship between an input and an output, including a phase difference between an input and an output and a phase relationship curve between an input and an output.
(11) Antenna polarization manner indication information of the first device.

The antenna polarization manner indication information may be used to indicate antenna polarization information of the first device, that is, a polarization manner of a transmit antenna and/or a receive antenna, such as vertical polarization, horizontal polarization, cross polarization, or circular polarization.

In step 302, that the first device receives the sensing configuration information may include: The first device receives the sensing configuration information from the second device, or the first device receives the sensing configuration information from the third device.

In some embodiments, the sensing configuration information includes at least one of the following:
antenna port configuration information, used to indicate an antenna port used by the first device to send the first signal, that is, indicate which antenna ports are used by the first device to send the first signal;
time domain sensing information, used to indicate a time domain resource used by the first device to send the first signal, that is, indicate time domain resources (such as slots or symbols) on which the first device sends the first signal; and
power configuration information, used to indicate power at which the first device sends the first signal, that is, indicate power at which the first device sends the first signal on a specified time domain resource.

In this embodiment of this application, the sensing configuration information is used to perform the sensing service or the integrated sensing and communication service. Further, the sensing configuration information may be further used to configure at least one of the following:
a waveform type, for example, at least one of orthogonal frequency division multiplexing (OFDM), a single-carrier frequency division multiplex access (SC-FDMA) technology, orthogonal time frequency space (OTFS), a frequency modulated continuous wave (FMCW), and a pulse signal;
a sub-carrier spacing, for example, a sub-carrier spacing of an OFDM system, for example, 30 KHz;
a guard interval, for example, a time interval between a moment at which sending of a signal ends and a moment at which a latest echo signal of the signal is received, where this parameter is directly proportional to a maximum sensing distance, for example, this parameter may be obtained through calculation of 2dₘₐₓ/c, where dₘₐₓ represents the maximum sensing distance (which is a sensing requirement), and for a self-transmitted and self-received sensing signal, dₘₐₓ represents a maximum distance between a receiving/transmitting point of a sensing signal and a signal transmitting point, and in some cases, an OFDM signal cyclic prefix (CP) may be used to indicate a minimum guard interval;
bandwidth, where this parameter is inversely proportional to distance resolution, and may be obtained based on c/(2Δd), where Δd represents the distance resolution (which is a sensing requirement), and c represents a speed of light;
burst (burst) duration, where this parameter is inversely proportional to rate resolution (which is a sensing requirement), this parameter is a time span of a sensing signal and is mainly used to calculate a Doppler frequency offset, and this parameter may be obtained through calculation of c/(2f_{c}Δv), where Δv represents the rate resolution, and f_{c} represents a carrier frequency of the sensing signal;
a time domain interval, where this parameter may be obtained through calculation of c/(2f_{c}v_{range}), where v_{range} represents a maximum rate minus a minimum speed (which is a sensing requirement), and this parameter is a time interval between two adjacent sensing signals;
transmit signal power, for example, one value is taken every 2 dBm from −20 dBm to 23 dBm;
a signal format, which is, for example, an SRS, a DMRS, or a PRS, or another predefined signal and information such as a related sequence format;
a signal direction, for example, a direction of a sensing signal or beam information;
a time resource, for example, an index of a slot in which a sensing signal is located or a symbol index of the slot, where time resources are classified into two types: one-time time resources, where for example, an omnidirectional sensing signal is sent on one symbol; and non-one-time time resources, such as a plurality of groups of periodic time resources or discontinuous time resources (which may include start time and end time), where each group of periodic time resources are used to send sensing signals in a same direction, and beam directions on different groups of periodic time resources are different;
a frequency resource, including a center frequency, bandwidth, a resource block (RB) or a sub-carrier, a reference point A, a start bandwidth location, and the like of a sensing signal;
a quasi co-location (QCL) relationship, where for example, a sensing signal includes a plurality of resources, each resource is QCL with one SSB, and the QCL includes a type A, a type B, a type C, or a type D;
antenna configuration information of a sensing node (a base station or a terminal), including at least one of the following:
an ID of an antenna array element or an antenna port used to send and/or receive a sensing signal;
an ID of a panel used to send and/receive a sensing signal and an array element ID;
location information (which may be represented by Cartesian coordinates (x, y, z) or spherical coordinates (ρ, φ, θ)) of an antenna array element used to send and/or receive a sensing signal relative to a specific local reference point on an antenna array;
location information (which may be represented by Cartesian coordinates (x, y, z) or spherical coordinates (ρ, φ, θ)) of a panel used to send and/or receive a sensing signal relative to a specific local reference point on an antenna array, and location information (which may be represented by Cartesian coordinates (x, y, z) or spherical coordinates (ρ, φ, θ)) of antenna array elements in a selected panel that are used to send a sensing signal relative to a specific unified reference point (such as a panel center point) of the panel;
bitmap information of an antenna array element, where for example, “1” is used to indicate that the array element is selected for sending and/or receiving a sensing signal, and “0” is used to indicate that the array element is not selected, or vice versa;
bitmap information of an array panel, where for example, “1” is used to indicate that the panel is selected for sending and/or receiving a sensing signal, and “0” is used to indicate that the panel is not selected, or vice versa;
bitmap information of an array panel and bitmap information of an array element in a selected panel, where for example, “1” is used to indicate that the array element is selected for sending and/or receiving a sensing signal, and “0” is used to indicate that the array element is not selected, or vice versa; and
amplitude and phase gain information of an antenna array element, that is, pattern (pattern) information of the antenna array element.

In some embodiments, the method further includes:
sending, by the first device, the first signal to a third device or a reference node, where the third device is a network side device, and the reference node is a reference node that participates in the sensing service or the integrated sensing and communication service.

In this implementation, a purpose of sending, by the first device, the first signal to the third device is to enable the third device to obtain a random phase measurement value based on the first signal. In this way, when a computing capability of the second device is limited, the third device may calculate the random phase measurement value.

A purpose of sending, by the first device, the first signal to the reference node is to enable the reference node to reflect the first signal to the second device or the third device, to assist the second device or the third device in obtaining the random phase measurement value and/or a reference path parameter measurement value.

In some embodiments, both the first device and the second device are terminals.

Before the first device sends the first information, the method further includes:
sending, by the first device, second information to a fourth device, where the second information is used to assist the fourth device in determining that the first device is a device that sends the first signal, and the fourth device is a network side device.

In this implementation, the second information may be understood as capability information of the first device. Correspondingly, the second device may also send fourth information to the fourth device, and the fourth information may be understood as capability information of the second device. When two terminals participate in receiving and sending of a sensing signal, the two terminals may report respective capability information to the fourth device to assist the fourth device in determining which one of the two terminals performs sending and which one of the two terminals performs receiving.

When this embodiment of this application relates to the third device and the fourth device, the third device and the fourth device may be a same network side device, or may be different network side devices.

In some embodiments, the second information includes at least one of the following:
antenna information of the first device, which may include information such as a total quantity of antenna ports and an antenna array type;
status information of the first device, which may include information such as a speed value, a speed direction, and an antenna panel orientation;
transmit power information of the first device, which may include information such as average transmit power and maximum transmit power;
receiving sensitivity information of the first device;
battery level information of the first device; and
computing capability information of the first device.

Correspondingly, for the fourth information sent by the second device to the fourth device, reference may also be made to the foregoing second information.

The related implementation of the sensing method corresponding to the first device side is described above. A related implementation of a sensing method corresponding to a second device side is to be described blow.

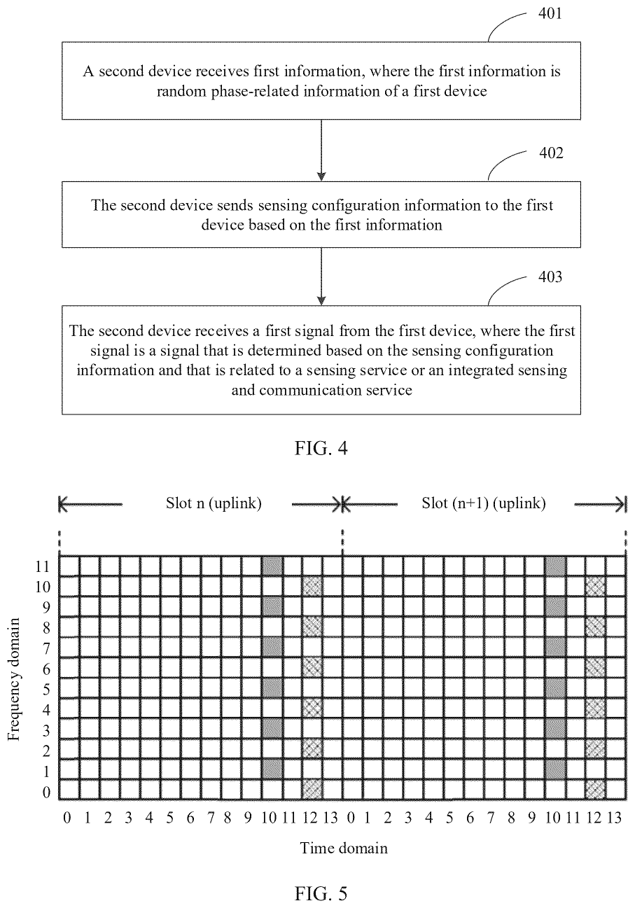

FIG. 4 is a flowchart of a sensing method according to an embodiment of this application. As shown in FIG. 4, the sensing method includes the following steps:
Step 401: A second device receives first information, where the first information is random phase-related information of a first device.
Step 402: The second device sends sensing configuration information to the first device based on the first information.
Step 403: The second device receives a first signal from the first device, where the first signal is a signal that is determined based on the sensing configuration information and that is related to a sensing service or an integrated sensing and communication service.

As described above, the second device is a device that receives a sensing signal, that is, a device that receives the first signal. The second device may be a terminal or a network side device. The first device is a device that sends a sensing signal, that is, a device that sends the first signal. The first device is a terminal, and the first device may have at least one antenna port. When the second device is a terminal, the first device and the second device are different terminals.

In step 401, that the second device receives the first information may include: the second device receives the first information from the first device.

In step 402, after receiving the first information, the second device may determine the sensing configuration information based on the first information, and send the determined sensing configuration information to the first device.

It should be noted that, in a case that the second device is a terminal, the second device may not participate in determining of the sensing configuration information, but a third device assists in determining the sensing configuration information. Correspondingly, the second device may receive the sensing configuration information from the third device.

In this embodiment of this application, the second device receives the random phase-related information of the first device, and the second device determines the sensing configuration information based on the random phase-related information of the first device, so that the first device can send a sensing signal based on the sensing configuration information. Through the foregoing process, impact exerted by a random phase on sensing performance can be resolved, so that the sensing performance can be improved.

In some embodiments, the first information includes at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

In this implementation, for related descriptions of the first information, reference may be made to corresponding descriptions in the implementation of the first device side.

In some embodiments, the first information includes at least one of the following:
a random phase parameter of at least one antenna port of the first device, where the random phase parameter includes at least one of a random phase value and a random phase value range;
a variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior;
a random phase parameter of at least one antenna port of the first device relative to a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

In this implementation, for related descriptions of the foregoing items included in the first information, reference may be made to corresponding descriptions in the implementation of the first device side.

In some embodiments, the sensing configuration information includes at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal.

In this implementation, for related descriptions of the sensing configuration information, reference may be made to corresponding descriptions in the implementation of the first device side.

In some embodiments, after the second device receives the first signal from the first device, the method further includes:
determining, by the second device, a random phase measurement value based on the first signal; and
determining, by the second device, a sensing measurement quantity measurement value based on the first signal and the random phase measurement value.

In this implementation, the second device may determine the random phase measurement value based on the received first signal, and determine the sensing measurement quantity measurement value based on the first signal and the random phase measurement value. The sensing measurement quantity measurement value may be referred to as a sensing result.

In this implementation, the second device, that is, the device that receives the first signal, determines the random phase measurement value. In this case, the second device may be a terminal or a network side device.

In this implementation, the second device may eliminate, by determining the random phase measurement value, a random phase in the first signal sent by the first device, to determine a relatively accurate sensing measurement quantity measurement value.

In some embodiments, after the second device receives the first signal from the first device, the method further includes:
determining, by the second device, a random phase calibration parameter or a random phase calibration manner based on the first signal; and
determining, by the second device, a sensing measurement quantity measurement value based on the random phase calibration parameter or the random phase calibration manner and the first signal; where
the random phase calibration parameter includes a reference path parameter measurement value; and
the random phase calibration manner includes at least one of a channel state information (CSI) quotient operation and a CSI conjugate product operation.

In this implementation, the second device may determine the random phase calibration parameter or the random phase calibration manner based on the received first signal, and eliminate, by using the random phase calibration parameter or the random phase calibration manner, the random phase in the first signal sent by the first device, to determine a relatively accurate sensing measurement quantity measurement value.

This implementation specifically includes the following two manners to eliminate the random phase:
Manner 1: The second device eliminates the random phase by using a reference path parameter estimation method.
Manner 2: The second device eliminates the random phase by using an operation such as a CSI quotient operation or a CSI conjugate product operation.

The foregoing reference path parameter measurement value may be understood as a measurement value of a reference path parameter. In this embodiment of this application, the reference path parameter may include at least one of the following:
a Doppler frequency of a reference path;
a Doppler frequency of a reference path and a change rate of the Doppler frequency;
a delay of a reference path;
a delay of a reference path and a change rate of the delay;
an azimuth angle of departure of a reference path;
an azimuth angle of departure of a reference path and a change rate of the azimuth angle of departure;
an elevation angle of departure of a reference path;
an elevation angle of departure of a reference path and a change rate of the elevation angle of departure;
an azimuth angle of arrival of a reference path;
an azimuth angle of arrival of a reference path and a change rate of the azimuth angle of arrival;
an elevation angle of arrival of a reference path;
an elevation angle of arrival of a reference path and a change rate of the elevation angle of arrival;
an amplitude of a reference path;
an amplitude of a reference path and a change rate of the amplitude;
a phase of a reference path; and
a phase of a reference path and a change rate of the phase.

The foregoing reference path may be a line of sight (LOS) path or a non line-of-sight (NLOS) path. When the reference path is a NLOS path, a reference node is required to participate in assisting estimation and calibration of the random phase. Therefore, the NLOS path may be understood as a first signal reflection path from the reference node.

A principle of calibrating the random phase based on the reference path parameter in Manner 1 is described as follows:

It is assumed that a transmit baseband signal is s₀(t), a carrier frequency is f_{c}, and a transmit signal is s(t)=s₀(t)e^{j2πf}^{_{c}}^{t}. In addition, it is assumed that a radio channel between a transmitter and a receiver is

$$H ( f , t ) = {\sum }_{l = 1}^{L} {a}_{l} ( t ) {e}^{- j 2 π f {τ}_{l}} {e}^{j 2 π {f}_{d , l} t} ,$$

where L is a total quantity of multi-paths in the channel, τₗ is a delay of an l^{th} multi-path, and f_{d,l} is a Doppler frequency of the first multi-path. In an ideal case, after the transmit signal passes through the channel, a received signal of an antenna of the receiver is

$$r ( t ) = {s}_{0} ( t ) {e}^{j 2 π {f}_{c} t} \cdot {\sum }_{l = 1}^{L} {a}_{l} ( t ) {e}^{- j 2 π {f}_{c} {τ}_{l}} {e}^{j 2 π {f}_{d , l} t} .$$

For a sensing receiver, a signal s₀(t) and a carrier frequency f_{c} are known, and H(f,t) may be obtained based on the received signal r(t), that is, a CSI matrix including sensing information is obtained. Further, a sensing measurement quantity such as τₗ or f_{d,l} may be obtained by using a parameter estimation algorithm such as fast Fourier transform (FFT) or multiple signal classification (MUSIC). For a communication receiver, based on a known carrier frequency f_{c}, if CSI is obtained after down-conversion is performed on a received signal and channel estimation is completed, a baseband transmit signal s₀(t) may be obtained.

However, due to introduction of the random phase, the transmit signal changes into s(t)=s₀(t)e^{j2πf}^{_{c}}^{t}e^{jφ(t)}, where φ(t) is the random phase.

For the sensing receiver, a received signal of an antenna is:

$$\begin{matrix}r ( t ) = {s}_{0} ( t ) {e}^{j 2 π {f}_{c} t} {e}^{j φ ( t )} \cdot {\sum }_{l = 1}^{L} {a}_{l} ( t ) {e}^{- j 2 π {f}_{c} {τ}_{l}} {e}^{j 2 π {f}_{d , l} t} , \\ = {s}_{0} ( t ) {e}^{j 2 π {f}_{c} t} \cdot {\sum }_{l = 1}^{L} {a}_{l} ( t ) {e}^{- j 2 π {f}_{c} {τ}_{l}} {e}^{j 2 π {f}_{d , l} t} {e}^{j φ ( t )} ,\end{matrix} \qquad ( 1 )$$

After down-conversion, an obtained channel estimation with random phase deflection is:

$$\begin{matrix}{H}^{′} ( f , t ) = {\sum }_{l = 1}^{L} {a}_{l} ( t ) {e}^{- j 2 π {f}_{c} {τ}_{l}} {e}^{j 2 π {f}_{d , l} t} {e}^{j φ ( t )} , \\ = {\sum }_{l = 1}^{L} {a}_{l} ( t ) {e}^{- j 2 π {f}_{c} {τ}_{l}} {e}^{j 2 π {f}_{d , l}^{′} t} ,\end{matrix} \qquad ( 2 )$$

When random phases φ(t) introduced at sampling moments t are different, that is, φ(tⱼ)−φ(tᵢ)≠0, i<j, a Doppler frequency obtained based on two adjacent channel estimations without considering interference and noise is

$${f}_{d , l}^{′} ( t ) = {f}_{d , l} + Δ f ( t ) = {f}_{d , l} + \frac{φ ( {t}_{j} ) - φ ( {t}_{i} )}{{t}_{j} - {t}_{i}} \neq {f}_{d , l} .$$

Because many mutually different spurious Doppler frequency components may be obtained based on using the parameter estimation algorithm such as FFT or MUSIC in a plurality of times of sampling, real Doppler cannot be accurately estimated ultimately.

It should be noted that an uplink random phase acts on all multi-paths of the CSI, and a random phase value is the same for all the multi-paths (see equations (1) and (2)).

An optional calibration method process is as follows: It is assumed that a real delay value of any l^{th} multi-path is known to be τₗ (which is usually a LOS path, and may be any NLOS path in some cases, for example, a NLOS reflection path of a known sensing reference node (such as a RIS or a BSC)). A measured delay of the l^{th} multi-path is τₗ′. It is assumed herein that due to another non-ideal factor, Δτ=τₗ′−τₗ, and delay calibration is first performed on all multi-paths of a CSI matrix, that is,

$$\begin{matrix}{H}_{1} ( f , t ) = {e}^{j 2 π {f}_{c} [ {τ}_{l}^{′} - {τ}_{l} ]} \cdot {\sum }_{l = 1}^{L} {a}_{l} ( t ) {e}^{- j 2 π {f}_{c} {τ}_{l}^{′} ( t )} {e}^{j 2 π {f}_{d , l}^{′} t} \\ = {\sum }_{l = 1}^{L} {a}_{l} ( t ) {e}^{- j 2 π {f}_{c} {τ}_{l}} {e}^{j 2 π {f}_{d , l}^{′} t} .\end{matrix} \qquad ( 4 )$$

In another aspect, it is assumed that a real Doppler frequency value of any l^{th} multi-path in a specific time period T is known to be f_{d,l} (which is also usually a LOS path, and may be a NLOS path in some cases). Doppler calibration is performed based on a CSI matrix obtained after delay calibration. First, it is necessary to extract a multi-path complex amplitude (including Doppler) with a known delay τₗ based on the CSI matrix, and there is the following by using maximum likelihood estimation.

$$\begin{matrix}{H}_{{τ}_{l}}^{′} ( f , t ) = {e}^{j 2 π {f}_{c} {τ}_{l}} \cdot {H}_{1} ( f , t ) \\ = {e}^{j 2 π {f}_{c} {τ}_{l}} \cdot {\sum }_{l = 1}^{L} {a}_{l} ( t ) {e}^{- j 2 π {f}_{c} {τ}_{l}} {e}^{j 2 π {f}_{d , l}^{′} t} \\ = {a}_{l} ( t ) {e}^{j 2 π {f}_{d , l}^{′} t} + {\sum }_{k = 1 , k \neq 1}^{L} {a}_{k} ( t ) {e}^{- j 2 π {f}_{c} ( {τ}_{k} - {τ}_{l} )} {e}^{j 2 π {f}_{d , l}^{′} t} \\ \approx {a}_{l} ( t ) {e}^{j 2 π {f}_{d , l}^{′} t} .\end{matrix} \qquad ( 5 )$$

Doppler of this path may be calibrated to obtain calibrated CSI at a moment tₛ in the time period T (where tₛ is a time difference relative to a reference moment), that is,

$$\begin{matrix}{H}_{c} ( f , {t}_{s} ) = {e}^{j 2 π Δ {f}_{d , l} {t}_{s}} \cdot {H}_{1} ( f , t ) \\ = {e}^{j 2 π ( {f}_{d , l} - {f}_{d , l}^{′} ) {t}_{s}} \cdot {e}^{j 2 π {f}_{c} ( {τ}_{l}^{′} - {τ}_{l} )} \cdot {\sum }_{l = 1}^{L} {a}_{l} ( {t}_{s} ) {e}^{- j 2 π {f}_{c} {τ}_{l}^{′} ( t )} {e}^{j2 π {f}_{d , l}^{′} {τ}_{s}} \\ = {\sum }_{l = 1}^{L} {a}_{l} ( {t}_{s} ) {e}^{- j 2 π {f}_{c} {τ}_{l}} {e}^{j 2 π {f}_{d , l} {t}_{x}} .\end{matrix} \qquad ( 6 )$$

where
Δf_{d}=f_{d,l}−f_{d,l}′. In this case, errors of sensing measurement quantities τₗ and f_{d,l} of an l^{th} multi-path are eliminated. Because an error caused by the random phase has a same effect on all multi-paths, errors caused by the random phase to all other multi-paths can also be eliminated. It should be noted that, when the Doppler frequency is calibrated, because a random error has different values during different sampling (in approximately uniform random distribution in a specific range of radians), CSI samples need to be calibrated one by one based on equation (6). In addition, it is generally impossible to determine the real complex amplitude aₗ of a first multi-path in the time period T. Therefore, during calibration, samples at different moments tₛ need to have a uniform reference moment (which may be generally selected as a sampling moment of a first sample in the time period T), to determine a value of tₛ and a phase calibration value of each CSI sample. In other words, the foregoing Doppler calibration is essentially calibration of relative phases between a plurality of consecutive CSI samples.

Further, a relatively practical method for estimating random phases at different moments is further provided, and is described as follows:

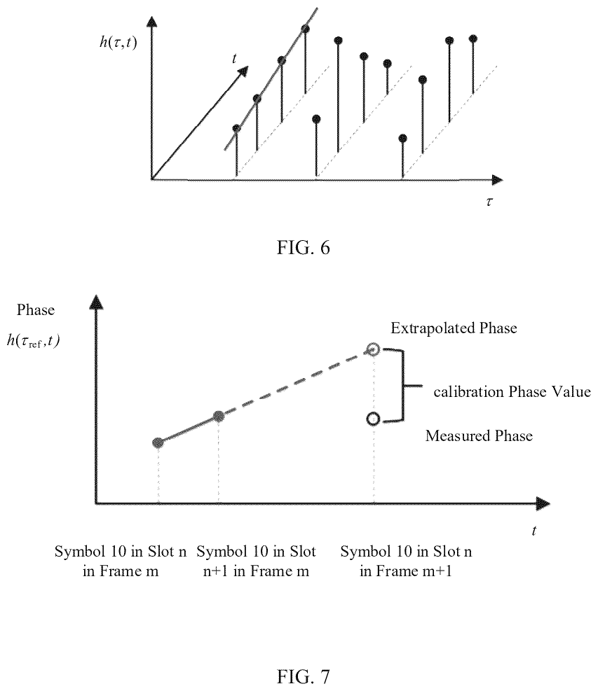

It is assumed that a pilot (reference signal)/sensing signal for random phase estimation is placed on at least two different uplink slots in a same uplink period, as shown in FIG. 5. Generally, in one uplink period, at least two uplink slots are required. For a device that has a plurality of transmit radio frequency links, each radio frequency link needs to have at least two uplink slots. A receive end obtains a channel estimation based on the pilot (reference signal)/sensing signal for random phase estimation, and performs inverse fast Fourier transform (IFFT) on the channel estimation in frequency domain to obtain an impulse response of the channel. Impulse responses at a plurality of different moments are correspondingly obtained for a plurality of uplink slots, as shown in FIG. 6. A purpose of an IFFT operation is to obtain a reference path (which is generally a LOS path or a NLOS path constructed by the reference node) parameter of the channel, for example, a delay, an amplitude, or a phase of the reference path.

Generally, there is no random phase deflection between different uplink slots in a same uplink period. It is assumed that interval time of different uplink slots meets a nearly linear phase change of the reference path of the channel. Based on phases of channel reference paths of at least two different uplink slots in the uplink period, a reference path phase at an uplink slot moment of a next uplink period may be easily extrapolated. However, after uplink-downlink switching is performed, random phase deflection (a random phase difference) is introduced to the reference path phase at the uplink slot moment of the next uplink period. As shown in FIG. 7, a phase difference between an extrapolated phase of the reference path and an actually measured phase is a random phase value that needs to be estimated. It should be noted that, based on different Doppler values of actual reference paths, a slope of a broken line in FIG. 7 may be positive, negative, or 0. A same operation is performed on different uplink slots to obtain all random phase values. Corresponding random phase values are compensated for in channel estimations/received signals of all different uplink slots, so that Doppler of a target signal can be accurately measured.

Because random phases of different radio frequency links are different, and there is a random phase difference between different antenna ports, an error exists in angle measurement. Further, a method for estimating random phases of different antenna ports is further provided, and is described as follows:

It is assumed that the transmitter has four antenna ports (four independent radio frequency links), and when the receive end estimates an angle of departure of a signal based on received transmit signals (for example, an azimuth angle of departure is used as an example for description, and is represented by θ) of the four ports, phase differences of the transmit signals of the ports need to be obtained. However, due to impact from a random phase of each port, signal transmission directions of the antenna ports are different from a perspective of a receiver side (that is, an “equivalent signal transmit direction” in FIG. 8).

First, the receive end obtains channel estimations of a plurality of transmit antenna ports based on the pilot (reference signal)/sensing signal used for random phase estimation, and separately performs IFFT on a channel estimation of each port in frequency domain to obtain an impulse response of the channel, as shown in FIG. 9. A purpose of an IFFT operation is to obtain a reference path (which is generally a LOS path or a NLOS path constructed by the reference node) parameter of the channel, for example, a delay, an amplitude, or a phase of the reference path.

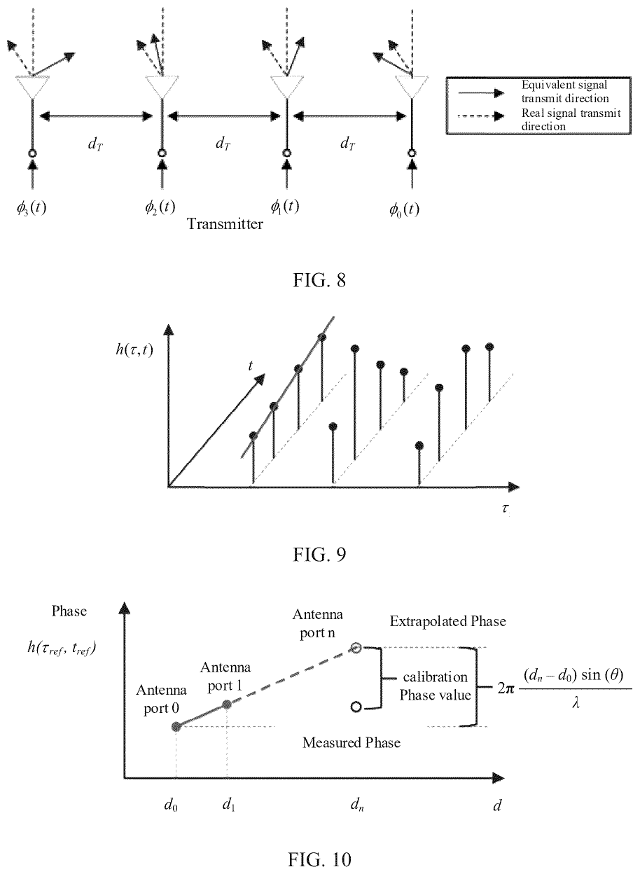

It is assumed that a transmitter array is a linear array (a same principle applies to other arrays), and a reference path phase ϕ₀(t) of an antenna port 0 is used as a reference phase, and it is assumed that an angle of departure of the reference path is known to be θ. In this case, a reference path phase of an antenna port n needs to be

$${ϕ}_{n}^{′} ( t ) = {ϕ}_{0} ( t ) + 2 π \frac{( {d}_{n} - {d}_{0} ) sin ( θ )}{λ} ,$$

where d₀, dₙ are respectively a distance between the antenna port 0 and a reference location of an antenna array and a distance between the antenna port n and the reference location of the antenna array, and λ is a signal wavelength, as shown in FIG. 10. An actual reference path phase of the antenna port n is ϕₙ(t) Therefore, a random phase value that needs to be calibrated for the antenna port n is Δϕₙ=ϕₙ(t)−ϕₙ′(t). It should be noted that, based on different angle values of an actual reference path, a slope of a broken line in FIG. 10 may be positive, negative, or 0. The foregoing operation is sequentially performed on antenna ports 1, 2, . . . , and n to obtain random phase values that need to be calibrated for all the antenna ports. Corresponding random phase values are compensated for in channel estimations/received signals of all the antenna ports, so that an angle of a target signal can be accurately measured.

A principle of calibrating the random phase based on the CSI quotient operation (or the CSI conjugate product operation) in Manner 2 is described below.

A sensing signal transmitter or a sensing signal receiver is equipped with a plurality of antennas. Because the plurality of antennas often use a same clock source, a channel delay and Doppler may be calibrated by using the CSI quotient operation or the CSI conjugate product operation, and errors introduced by a frequency offset or a random phase are eliminated. This method is simple to implement and has a relatively small computation amount, but at least one of the transmitter and the receiver needs to be equipped with a plurality of antennas. Moreover, non-ideal factors (such as a frequency offset or a random phase) introduced into sensing measurement quantity measurement values that are obtained by using the antennas are the same.

For example, a channel estimation of an antenna 1 of the sensing signal receiver is

$${H}_{1}^{′} ( f , t ) = {H}_{1} ( f , t ) {e}^{j φ} ,$$

where H₁(f,t) is real CSI of the antenna 1, and φ is a phase difference introduced by a non-ideal factor. Similarly, a channel estimation of an antenna 2 is

$${H}_{2}^{′} ( f , t ) = {H}_{2} ( f , t ) {e}^{j φ} ,$$

and H₂(f,t) is real CSI of the antenna 2.

A formula of the CSI quotient operation is:

$${H}_{ratio}^{12} ( f , t ) = \frac{{H}_{1} ( f , t ) {e}^{j φ}}{{H}_{2} ( f , t ) {e}^{j φ}} = \frac{{H}_{1} ( f , t )}{{H}_{2} ( f , t )}$$

A formula of the CSI conjugate product operation is:

$${H}_{product}^{12} ( f , t ) = {H}_{1} ( f , t ) {e}^{j φ} \cdot {H}_{2}^{*} ( f , t ) {e}^{- j φ} = {H}_{1} ( f , t ) \cdot {H}_{2}^{*} ( f , t )$$

It can be learned that a phase difference introduced by the non-ideal factor is eliminated.

Then, the sensing measurement quantity is extracted based on

$${H}_{ratio}^{12} ( f , t ) or {H}_{product}^{12} ( f , t ) ,$$

and details are not described herein again.

For the CSI quotient operation, reference may be made to the following reference document [5].
[5] Zeng, Youwei, et al. “FarSense: Pushing the range limit of WiFi-based respiration sensing with CSI ratio of two antennas.” Proceedings of the ACM on Interactive, Mobile, Wearable and Ubiquitous Technologies 3.3 (2019): 1-26.

In some embodiments, the method further includes:
sending, by the second device, the sensing configuration information to a third device, where the third device is a network side device;
receiving, by the second device, third information from the third device, where the third information includes a random phase measurement value, and the random phase measurement value is determined based on the sensing configuration information and the first signal; and
determining, by the second device, a sensing measurement quantity measurement value based on the first signal and the random phase measurement value.

In this implementation, when a computing capability of the second device is limited, the second device may send the sensing configuration information to the third device. In this way, the third device may assist in determining the random phase measurement value.

In this embodiment of this application, after determining the sensing measurement quantity measurement value (or a sensing result), the second device may further send the sensing measurement quantity measurement value (or the sensing result) to a sensing function network element.

The sensing measurement quantity measurement value may be understood as a measurement value of a sensing measurement quantity. In this embodiment of this application, the sensing measurement quantity may include at least one of the following:
a first-level measurement quantity (which is also referred to as a received signal/original channel information), which may include, for example, a received signal/channel response complex result, an amplitude/phase, an I-path/Q-path, and operation results thereof (operations include addition, subtraction, multiplication, and division, matrix addition, subtraction, and multiplication, matrix transposition, a trigonometric operation, a square root operation, a power operation, and the like, along with a threshold detection result, a maximum/minimum value extraction result, and the like of results of the foregoing operations; and the operations further include fast Fourier transform (FFT)/inverse fast Fourier transform (IFFT), discrete Fourier transform (DFT)/inverse discrete Fourier transform (IDFT), two-dimensional fast Fourier transform (2D-FFT), three-dimensional fast Fourier transform (3D-FFT), matched filtering, an autocorrelation operation, wavelet transform, digital filtering, and the like, along with a threshold detection result, a maximum/minimum value extraction result, and the like of results of the foregoing operations);
a second-level measurement quantity (which is also referred to as a basic measurement quantity), which may include, for example, a delay, Doppler, an angle, strength, and a multi-dimensional combination expression thereof;
a third-level measurement quantity (which is also referred to as a basic attribute/state), which may include, for example, at least one of a distance, a speed, an orientation, a spatial location, and an acceleration; and
a fourth-level measurement quantity (which is also referred to as an advanced attribute/state), which may include, for example, at least one of whether a sensing target exists, a trajectory of a sensing target, an action, an expression, a vital sign, a quantity, an imaging result, weather, air quality, a shape, a material, and a composition.

Optionally, the sensing measurement quantity further includes corresponding tag information, for example, may include at least one of the following: sensing signal identifier information, sensing measurement configuration identifier information, sensing service information (for example, a sensing service ID), a data subscription ID, measurement quantity usage (for example, communication, sensing, or sensing and communication), time information, sensing node information (for example, a node ID, a node location, or a device orientation), sensing link information (for example, a sensing link sequence number or a sending/receiving node identifier), sensing measurement quantity description information (a form is, for example, an amplitude value, a phase value, or a complex value of an amplitude and a phase, and a resource type is, for example, a time domain measurement result or a frequency domain resource measurement result), and measurement quantity indicator information (such as a signal-to-noise ratio (SNR) or a sensing SNR).

In some embodiments, both the first device and the second device are terminals.

Before the second device receives the first information, the method further includes:
sending, by the second device, fourth information to a fourth device, where the fourth information is used to assist the fourth device in determining that the second device is a device that receives the first signal, and the fourth device is a network side device.

In some embodiments, the fourth information includes at least one of the following:
antenna information of the second device;
status information of the second device;
transmit power information of the second device;
receiving sensitivity information of the second device;
battery level information of the second device; and
computing capability information of the second device.

In some embodiments, the method further includes:
obtaining, by the second device, fifth information, where the fifth information is communication-related information of the first device; and
the sending, by the second device, sensing configuration information to the first device based on the first information includes:
sending, by the second device, the sensing configuration information to the first device based on the first information and the fifth information.

In this implementation, the fifth information may be used to assist in determining parameter configuration information required by the sensing service, and the fifth information may include channel information and communication parameter configuration information.

In some embodiments, the fifth information includes:
channel state information between the first device and the second device;
cascaded channel state information between the first device and the reference node;
cascaded channel state information between the second device and the reference node, which includes at least uplink cascaded channel state information, downlink cascaded channel state information, and cascaded channel coherence time;
communication parameter configuration information between the first device and the second device;
channel state information between the first device and a network side device;
channel state information between the second device and the network side device;
communication parameter configuration information between the first device and the network side device; and
communication parameter configuration information between the second device and the network side device.

In this implementation, the foregoing channel state information may include at least uplink channel state information, downlink channel state information, and channel coherence time.

The cascaded channel state information includes at least uplink cascaded channel state information, downlink cascaded channel state information, and cascaded channel coherence time. The reference node may be a RIS, a BSC, or another passive device or object used for assisting in sensing.

The communication signal parameter configuration information may include at least uplink communication signal parameter configuration information and downlink communication signal parameter configuration information. Herein, for related explanations of the communication signal parameter configuration information, reference may be made to related descriptions of the foregoing sensing configuration information.

In some embodiments, in a case that a sensing target is an active target, the fifth information further includes at least one of the following:
channel state information between the second device and the sensing target;
channel coherence time between the second device and the sensing target;
channel state information between the first device and the sensing target; and
channel coherence time between the first device and the sensing target.

When the sensing target is an active target, the sensing target may receive and send a signal, for example, a terminal, a BSC, and a radio frequency identification (RFID) tag.

The related implementation of the sensing method corresponding to the second device side is described above. A related implementation of a sensing method corresponding to a third device side is to be described below.

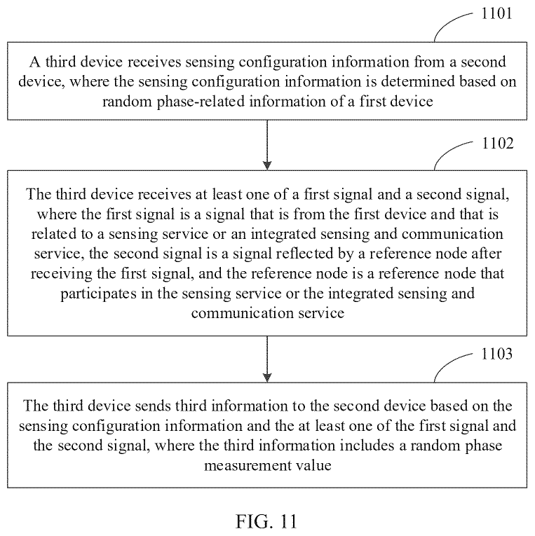

FIG. 11 is a flowchart of a sensing method according to an embodiment of this application. As shown in FIG. 11, the sensing method includes the following steps:
Step 1101: A third device receives sensing configuration information from a second device, where the sensing configuration information is determined based on random phase-related information of a first device.
Step 1102: The third device receives at least one of a first signal and a second signal, where the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service.
Step 1103: The third device sends third information to the second device based on the sensing configuration information and the at least one of the first signal and the second signal, where the third information includes a random phase measurement value.

As described above, the third device is a network side device. When a computing capability of the second device is limited, the second device may send the sensing configuration information to the third device. In this way, determining of the random phase measurement value may be assisted by using the third device.

In this embodiment of this application, the third device determines the random phase measurement value, and sends the determined random phase measurement value to the second device, so that the second device can obtain a relatively accurate sensing measurement quantity measurement value (or a sensing result) based on the random phase measurement value. It can be learned that, through the foregoing process, impact exerted by a random phase on sensing performance can be resolved, so that the sensing performance can be improved.

The related implementations of the sensing method in the embodiments of this application are respectively described above from perspectives of the first device side, the second device side, and the third device side.

It should be noted that in the embodiments of this application, in addition to the first device, the second device, and the third device, related devices that participate in a related process of the sensing method may further include related devices such as a reference node, a fourth device, and a sensing function network element. The third device and the fourth device may be a same network side device.

A combination of the related devices that participate in the related process of the sensing method may be, for example, as follows:
Combination 1: A first device+a second device.
Combination 2: A first device+a second device+a reference node.
Combination 3: A first device+a second device+a third device.
Combination 4: A first device+a second device+a third device+a reference node.

An overall procedure of the sensing method in the embodiments of this application is described below.

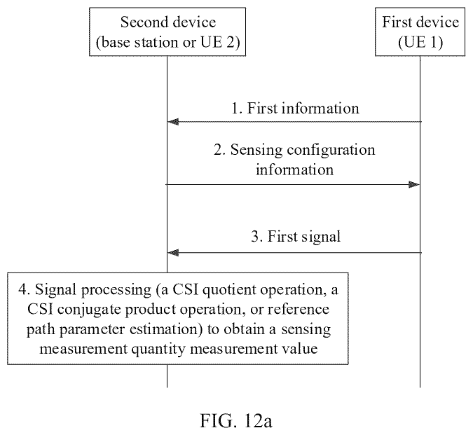

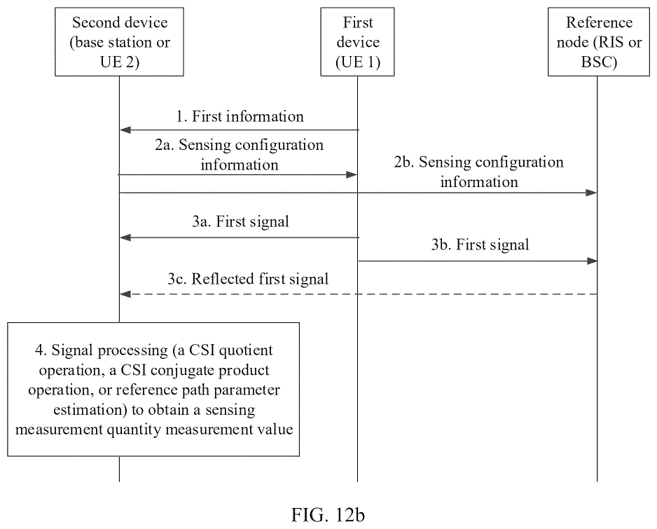

FIG. 12a is an overall flowchart of a sensing method according to an embodiment of this application. As shown in FIG. 12a, the sensing method includes the following steps:

Step 1: A first device sends first information to a second device, where the first device is a device that sends a first signal, and the second device is a device that receives the first signal.

Optionally, the first information includes at least one of the following:
a random phase value or a random phase value range of at least one antenna port of the first device;
a random phase value difference of the at least one antenna port before and after uplink-downlink switching of the first device, that is, a difference obtained by subtracting a random phase value existing before uplink-downlink switching from a random phase value obtained after uplink-downlink switching, or a difference obtained by subtracting a random phase value obtained after uplink-downlink switching from a random phase value existing before uplink-downlink switching;
a difference between a random phase value of at least one first port of the first device and a random phase value of a reference port, where the reference port may be any antenna port of the first device, and the first port is an antenna port that is on the first device and that is different from the reference port;
indexes of at least two antenna ports with a same random phase of the first device;
a mapping relationship between a physical antenna and at least two antenna ports with a same random phase of the first device, that is, a correspondence between a port index and a physical antenna index;
information about a physical antenna to which at least two antenna ports with a same random phase of the first device are mapped, including:
location information of the physical antenna, that is, location information of the physical antenna relative to a local reference point on an antenna array of the first device, where the local reference point may be any physical antenna location of the antenna array of the first device or a physical center location of an antenna panel of the first device;
orientation information of the physical antenna;
a 2D/3D radiation pattern of the physical antenna;
a quantity of ports in at least one group of antenna ports with a same random phase of the first device;
indication information indicating whether at least some (including all) antenna ports of the first device have a same random phase/different random phases, where for example, a bitmap is used for indication, and an optional method may be as follows: ‘0000’ indicates that random phases of four ports of UE are different, ‘0110’ indicates that random phases of a port 1 and a port 2 are the same and random phases of a port 0 and a port 3 are different, and “1111” indicates that random phases of the four ports are the same;
antenna switching manner indication information of the first device, including 1T1R, 1T2R, 1T4R, 1T6R, 1T8R, 2T2R, 2T4R, 2T6R, 2T8R, 4T4R, and 4T8R, where for example, 2T4R indicates that in a same uplink slot, a quantity of transmit antennas of the first device is 2, and in a same downlink slot, a quantity of receive antennas of the first device is 4;
information about an amplitude and/or phase relationship between an input and an output of a power amplifier (PA) of at least one antenna port of the first device, including an amplitude ratio of the input to the output of the PA, a phase difference between the input and the output, an amplitude relationship curve between the input and the output, and a phase relationship curve between the input and the output; and
antenna polarization information of the first device, that is, a polarization manner of a transmit and/or receive antenna, such as vertical polarization, horizontal polarization, cross polarization, or circular polarization.

Step 2: The second device sends sensing configuration information to the first device based on the first information, where the sensing configuration information is used to perform a sensing service or an integrated sensing and communication service.

Optionally, the second device sends the sensing configuration information to a third device based on the first information, where the third device is a device configured to obtain a random phase measurement value.

Step 3: The first device sends the first signal to the second device based on the sensing configuration information.

Step 4: The second device processes (a CSI quotient operation, a CSI conjugate product operation, or reference path parameter estimation) the signal based on the received first signal, and further obtains a sensing measurement quantity measurement value (or a sensing result); or obtains a random phase measurement value, and further obtains a sensing measurement quantity measurement value (or a sensing result).

Optionally, the third device sends the obtained random phase measurement value to the second device, and the second device further obtains the sensing measurement quantity measurement value (or the sensing result) based on the obtained random phase measurement value.

Optionally, the second device sends the sensing measurement quantity measurement value (or the sensing result) to a sensing function network element.

FIG. 12a is an overall flowchart in a case that a reference node does not participate in sensing. When the reference node participates in sensing, reference may be further made to FIG. 12b.

As shown in FIG. 12b, the sensing method includes the following steps:
Step 1: A first device sends first information to a second device, where the first device is a device that sends a first signal, and the second device is a device that receives the first signal.
Step 2a: The second device sends sensing configuration information to the first device based on the first information, where the sensing configuration information is used to perform a sensing service or an integrated sensing and communication service.
Step 2b: The second device sends sensing configuration information to a reference node.
Step 3a: The first device sends the first signal to the second device based on the sensing configuration information.
Step 3b: The first device sends the first signal to the reference node.
Step 3c: The reference node reflects the first signal to the second device.
Step 4: The second device processes (a CSI quotient operation, a CSI conjugate product operation, or reference path parameter estimation) the signal based on the received first signal, and further obtains a sensing measurement quantity measurement value (or a sensing result); or obtains a random phase measurement value, and further obtains a sensing measurement quantity measurement value (or a sensing result).

It should be noted that this embodiment of this application is applicable to random phase measurement, estimation, and calibration of at least one antenna port of the first device at different uplink moments, and is also applicable to random phase measurement, estimation, and calibration of at least two different antenna ports of the first device. It should be understood that, through random phase measurement, estimation, and calibration operations, one of the following two effects may be achieved:
(1) Random phases of at least one antenna port of the first device at different uplink moments are eliminated, or random phases of at least two different antenna ports of the first device are eliminated, to further eliminate impact exerted by a random phase on Doppler measurement and/or angle measurement.
(2) A channel reference path phase of a specific antenna port at a specific uplink moment is used as a reference phase, so that a channel reference path phase of another antenna port and/or of the antenna port at another uplink moment keeps continuous and consistent with the reference phase, to eliminate impact exerted by a random phase on Doppler measurement and/or angle measurement.

It should be understood that the concept of “random phase” in this embodiment of this application also includes a difference between random phases. When this embodiment of this application is used to measure, estimate, and calibrate random phases of at least one antenna port of the first device at different uplink moments, impact exerted by the random phase on Doppler measurement can be eliminated. When this embodiment of this application is used to measure, estimate, and calibrate random phases of at least two different antenna ports of the first device, impact exerted by the random phase on angle (including an azimuth angle and an elevation angle) measurement can be eliminated.

For a method for estimating random phases of at least one antenna port of the first device at different uplink moments and a method for estimating random phases of at least two different antenna ports of the first device, reference may be made to the foregoing related descriptions.

This solution is further described below by using two embodiments based on different sensing nodes.

Embodiment 1: The first device is UE, and the second device is a base station (that is, a network side device).

Step 1: The UE sends first information to the base station, where the first information includes at least one of the following:
a random phase value or a random phase value range of at least one antenna port of the UE;
a random phase value difference of the at least one antenna port before and after uplink-downlink switching of the UE, that is, a difference obtained by subtracting a random phase value existing before uplink-downlink switching from a random phase value obtained after uplink-downlink switching, or a difference obtained by subtracting a random phase value obtained after uplink-downlink switching from a random phase value existing before uplink-downlink switching;
a difference between a random phase value of at least one first port of the UE and a random phase value of a reference port, where the reference port may be any antenna port of the UE, and the first port is an antenna port that is on the UE and that is different from the reference port;
indexes of at least two antenna ports with a same random phase of the UE;
indexes of at least two antenna ports with mutually different random phases of the UE;
a mapping relationship between a physical antenna and at least two antenna ports with a same random phase of the UE, that is, a correspondence between a port index and a physical antenna index;
information about a physical antenna to which at least two antenna ports with a same random phase of the UE are mapped, including:
location information of the physical antenna, that is, location information of the physical antenna relative to a local reference point on an antenna array of the UE, where the local reference point may be any physical antenna location of the antenna array of the UE or a physical center location of an antenna panel of the UE;
orientation information of the physical antenna;
a 2D/3D radiation pattern of the physical antenna;
a quantity of ports in at least one group of antenna ports with a same random phase of the UE;
indication information indicating whether at least some (including all) antenna ports of the UE have a same random phase/different random phases, where for example, a bitmap is used for indication, and an optional method may be as follows: ‘0000’ indicates that random phases of four ports of the UE are different, ‘0110’ indicates that random phases of a port 1 and a port 2 are the same and random phases of a port 0 and a port 3 are different, and “1111” indicates that the random phases of the four ports are the same;
antenna switching manner indication information of the UE, including 1T1R, 1T2R, 1T4R, 1T6R, 1T8R, 2T2R, 2T4R, 2T6R, 2T8R, 4T4R, and 4T8R, where for example, 2T4R indicates that in a same uplink slot, a quantity of transmit antennas of the UE is 2, and in a same downlink slot, a quantity of receive antennas of the UE is 4;
information about an amplitude and/or phase relationship between an input and an output of a power amplifier (PA) of at least one antenna port of the UE, including an amplitude ratio of the input to the output of the PA, a phase difference between the input and the output, an amplitude relationship curve between the input and the output, and a phase relationship curve between the input and the output; and
antenna polarization information of the UE, that is, a polarization manner of a transmit and/or receive antenna, such as vertical polarization, horizontal polarization, cross polarization, or circular polarization.

Optionally, the base station obtains fifth information, and the fifth information is used to assist in determining parameter configuration information required by a sensing service or an integrated sensing and communication service. The fifth information includes at least one of the following:
channel state information between the UE and the base station, including at least uplink channel state information, downlink channel state information, and channel coherence time;
cascaded channel state information from the UE to a reference node and from the reference node to the base station, including at least uplink cascaded channel state information, downlink cascaded channel state information, and cascaded channel coherence time, and the reference node may be a RIS, a BSC, or another passive device or object used for assisting in sensing; and
communication signal parameter configuration information, including uplink communication signal parameter configuration information and downlink communication signal parameter configuration information.

Optionally, the base station obtains sixth information of the reference node. The sixth information is used to assist the base station in obtaining a random phase measurement value and/or a reference path parameter measurement value. The sixth information includes a location of the reference node, a speed size, a speed direction, and antenna panel orientation information.

Step 2: The base station sends sensing configuration information to the UE based on the first information, where the sensing configuration information is used to perform a sensing service or an integrated sensing and communication service, and the sensing configuration information includes at least one of the following:
port configuration information indicating antenna ports used by the UE to send signals;
time configuration information indicating time resources (slots and symbols) on which the UE sends signals; and
power configuration information indicating power at which the UE sends a signal on a specified time domain resource.

Optionally, the base station or the UE sends the sensing configuration information to the reference node.

Step 3: The UE sends a first signal based on the sensing configuration information, and the base station processes (a CSI quotient operation, a CSI conjugate product operation, or reference path parameter estimation) the signal based on the received first signal, and further obtains a sensing measurement quantity measurement value (or a sensing result); or obtains a random phase measurement value, and further obtains a sensing measurement quantity measurement value (or a sensing result).

Optionally, step 4 is as follows: The base station sends the sensing measurement quantity measurement value (or the sensing result) to a sensing function network element.

Additional notes:
(1) Optionally, if random phase estimation and calibration need to be performed on a plurality of consecutive groups of uplink channel estimates/received first signals, steps 1 to 4 may be repeated until obtained plurality of uplink channel estimates or received first signals meet a sensing service requirement.
(2) Based on the first information, the base station may determine a signal processing method used for the sensing service or the integrated sensing and communication service, including: processing a signal by using a CSI quotient operation or a CSI conjugate product operation, and obtaining the sensing measurement quantity measurement value, for example, a Doppler frequency. In addition, a reference path parameter estimation method may also be used, and a reference path may be a LOS path or a NLOS path. When the reference path is a NLOS path, the reference node needs to participate in assisting in random phase estimation and calibration. For a specific procedure, reference may be made to FIG. 12b.
(3) If a sensing target is an active target, the second information further includes channel state information from the base station to the sensing target, channel state information from the sensing target to the base station, channel coherence time between the base station and the sensing target, channel state information from the UE to the sensing target, channel state information from the sensing target to the UE, and channel coherence time between the UE and the sensing target.

Embodiment 2: The first device is UE 1, and the second device is UE 2.

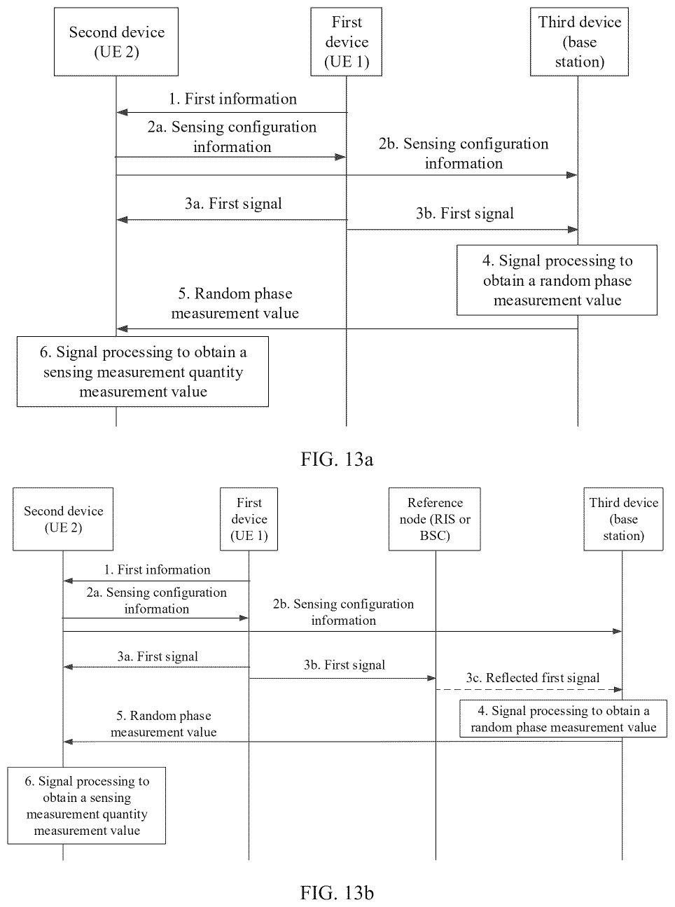

As shown in FIG. 13a and FIG. 13b, a sensing method includes the following steps:

Step 1: The UE 1 sends first information to the UE 2.

Optionally, the UE 1 sends the first information to the UE 2 and a base station.

Optionally, the UE 2 sends the first information to a base station.

The first information includes at least one of the following:
a random phase value or a random phase value range of at least one antenna port of the UE 1;
a random phase value difference of the at least one antenna port before and after uplink-downlink switching of the UE 1, that is, a difference obtained by subtracting a random phase value existing before uplink-downlink switching from a random phase value obtained after uplink-downlink switching, or a difference obtained by subtracting a random phase value obtained after uplink-downlink switching from a random phase value existing before uplink-downlink switching;
a difference between a random phase value of at least one first port of the UE 1 and a random phase value of a reference port, where the reference port may be any antenna port of the UE 1, and the first port is an antenna port that is on the UE 1 and that is different from the reference port;
indexes of at least two antenna ports with a same random phase of the UE 1;
a mapping relationship between a physical antenna and at least two antenna ports with a same random phase of the UE 1, that is, a correspondence between a port index and a physical antenna index;
information about a physical antenna to which at least two antenna ports with a same random phase of the UE 1 are mapped, including:
location information of the physical antenna, that is, location information of the physical antenna relative to a local reference point on an antenna array of the UE 1, where the local reference point may be any physical antenna location of the antenna array of the UE 1 or a physical center location of an antenna panel of the UE 1;
orientation information of the physical antenna;
a 2D/3D radiation pattern of the physical antenna;
a quantity of ports in at least one group of antenna ports with a same random phase of the UE 1;
indication information indicating whether at least some (including all) antenna ports of the UE 1 have a same random phase/different random phases, where for example, a bitmap is used for indication, and an optional method may be as follows: ‘0000’ indicates that random phases of four ports of the UE 1 are different, ‘0110’ indicates that random phases of a port 1 and a port 2 are the same and random phases of a port 0 and a port 3 are different, and “1111” indicates that the random phases of the four ports are the same;
antenna switching manner indication information of the UE 1, including 1T1R, 1T2R, 1T4R, 1T6R, 1T8R, 2T2R, 2T4R, 2T6R, 2T8R, 4T4R, and 4T8R, where for example, 2T4R indicates that in a same uplink slot, a quantity of transmit antennas of the UE 1 is 2, and in a same downlink slot, a quantity of receive antennas of the UE 1 is 4;
information about an amplitude and/or phase relationship between an input and an output of a power amplifier (PA) of at least one antenna port of the UE 1, including an amplitude ratio of the input to the output of the PA, a phase difference between the input and the output, an amplitude relationship curve between the input and the output, and a phase relationship curve between the input and the output; and
antenna polarization information of the UE 1, that is, a polarization manner of a transmit and/or receive antenna, such as vertical polarization, horizontal polarization, cross polarization, or circular polarization.

Optionally, at least one of the base station and the UE 2 obtains fifth information. The fifth information is used to assist in determining parameter configuration information required by a sensing service or an integrated sensing and communication service. The fifth information includes at least one of the following:
channel state information between the UE 1 and the UE 2, including at least (uplink and/or downlink) channel state information and channel coherence time between the UE 1 and the UE 2;
cascaded channel state information from the UE 1 to the reference node and from the reference node to the UE 2, including at least (uplink and/or downlink) cascaded channel state information and cascaded channel coherence time between the UE 1 and the reference node and between the reference node and the UE 2, and the reference node may be a RIS, a BSC, or another passive device or object used for assisting in sensing;
channel state information between the UE 1 and the base station, including at least (uplink and/or downlink) channel state information and channel coherence time between the UE 1 and the base station;
channel state information between the UE 2 and the base station, including at least (uplink and/or downlink) channel state information and channel coherence time between the UE 2 and the base station;
communication signal parameter configuration information between the UE 1 and the UE 2;
communication signal parameter configuration information between the UE 1 and the base station, including uplink communication signal parameter configuration information and downlink communication signal parameter configuration information; and
communication signal parameter configuration information between the UE 2 and the base station, including uplink communication signal parameter configuration information and downlink communication signal parameter configuration information.

Optionally, at least one of the base station and the UE 2 obtains sixth information of the reference node. The sixth information is used to assist at least one of the base station and the UE 2 in obtaining a random phase measurement value and/or a reference path parameter measurement value. The sixth information includes a location of the reference node, a speed size, a speed direction, and antenna panel orientation information.

Optionally, before this step, the base station obtains second information of the UE 1 and/or fourth information of the UE 2, where the second information and/or the fourth information are/is used to assist in determining a device that sends the first signal and a device that receives the first signal. The second information and/or the fourth information include/includes at least one of the following:
antenna information of the UE 1 and/or the UE 2, including a total quantity of antenna ports and an antenna array type;
status information of the UE 1 and/or the UE 2, including a speed value, a speed direction, and an antenna panel orientation;
information such as average transmit power, maximum transmit power, and receiver sensitivity of the UE 1 and/or the UE 2;
battery level information of the UE 1 and/or the UE 2; and
computing capability information of the UE 1 and/or the UE 2.

Step 2: (1-1) The base station sends sensing configuration information to the UE 1 and the UE 2 based on the first information.

Optionally, the base station sends fifth information to the UE 2, where the fifth information is used to assist the UE 2 in performing the sensing service or the integrated sensing and communication service. The fifth information includes at least one of the following: indication information of a method for calculating a sensing measurement quantity measurement value, and at least one piece of content of the first information of the UE 1.

(1-2) The UE 2 sends sensing configuration information to the UE 1 based on the first information.

Optionally, the UE 2 sends the sensing configuration information to the base station based on the first information.

The sensing configuration information is used to perform the sensing service or the integrated sensing and communication service, and the sensing configuration information includes at least one of the following:
port configuration information indicating antenna ports used by the UE 1 to send signals;
time configuration information indicating time resources (slots and symbols) on which the UE 1 sends signals; and
power configuration information indicating power at which the UE 1 sends a signal on a specified time domain resource.

Optionally, the base station, the UE 1, or the UE 2 sends the sensing configuration information to the reference node.

Step 3: (1) The UE 1 sends a first signal based on the sensing configuration information.

(2) The UE 1 sends the first signal based on the sensing configuration information, and the base station and the UE 2 receive the first signal. The base station obtains the random phase measurement value based on the received first signal, and sends the random phase measurement value to the UE 2. The UE 2 obtains the sensing measurement quantity measurement value (or a sensing result) based on the received first signal and the random phase measurement value.

Step 4: The base station obtains the random phase measurement value based on the first signal or a reflected first signal.

Step 5: The base station sends the random phase measurement value to the UE 2.

Step 6: The UE 2 processes (a CSI quotient operation, a CSI conjugate product operation, or reference path parameter estimation) the signal based on the received first signal, and further obtains the sensing measurement quantity measurement value (or the sensing result); or
the UE 2 obtains the random phase measurement value based on the received first signal, and further obtains the sensing measurement quantity measurement value (or the sensing result); or
the UE 2 obtains the sensing measurement quantity measurement value (or the sensing result) based on the received random phase measurement value.

Optionally, the UE 2 sends the sensing measurement quantity measurement value (or the sensing result) to the base station or a sensing function network element.

Additional notes:
(1) If random phase estimation and calibration need to be performed on a plurality of consecutive groups of uplink channel estimates/received first signals, steps 1 to 6 may be repeated until obtained plurality of uplink channel estimates or received first signals meet a sensing service requirement.
(2) Based on the first information, the base station may determine a signal processing method used for the sensing service or the integrated sensing and communication service, including: processing a signal by using a CSI quotient operation or a CSI conjugate product operation, and obtaining the sensing measurement quantity measurement value, for example, a Doppler frequency. In addition, a reference path parameter estimation method may also be used, and a reference path may be a LOS path or a NLOS path. When the reference path is a NLOS path, the reference node needs to participate in assisting in random phase estimation and calibration. For a specific procedure, reference may be made to FIG. 13b.
(3) For a problem of a limited computing capability of UE, a signal processing process of random phase estimation may be performed by the base station, and then the base station sends the random phase measurement value to the UE that is used as a device for receiving the first signal. Corresponding to FIG. 12a and FIG. 12b, FIG. 13a and FIG. 13b are schematic flowcharts of obtaining a random phase measurement value by a base station in two cases.
(4) If a sensing target is an active target, the second information further includes channel state information from the base station to the sensing target, channel state information from the sensing target to the base station, channel coherence time between the base station and the sensing target, channel state information from the UE 1 and/or the UE 2 to the sensing target, channel state information from the sensing target to the UE 1 and/or the UE 2, and channel coherence time between the UE 1 and/or the UE 2 and the sensing target.

In conclusion, through the foregoing process, impact exerted by a random phase on sensing performance (or integrated sensing and communication performance) can be resolved, so that the sensing performance can be improved.

The sensing method provided in the embodiments of this application may be performed by a sensing apparatus. In the embodiments of this application, a sensing apparatus provided in an embodiment of this application is described by using an example in which the sensing apparatus performs the sensing method.

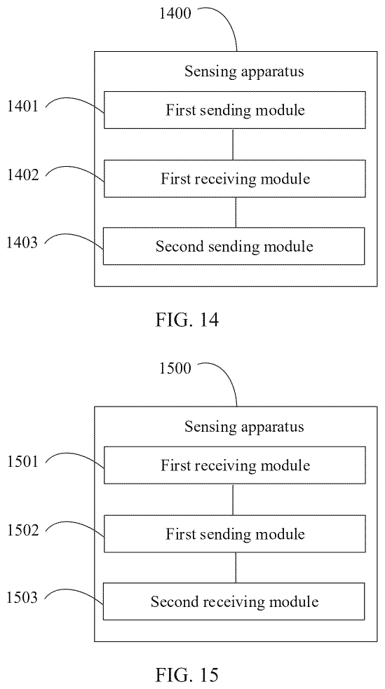

As shown in FIG. 14, an embodiment of this application further provides a sensing apparatus. The sensing apparatus may be applied to a first device, and the first device is a terminal. As shown in FIG. 14, the sensing apparatus 1400 includes:
a first sending module 1401, configured to send first information, where the first information is random phase-related information of the first device;
a first receiving module 1402, configured to receive sensing configuration information, where the sensing configuration information is determined based on the first information; and
a second sending module 1403, configured to send a first signal to a second device based on the sensing configuration information, where the first signal is a signal related to a sensing service or an integrated sensing and communication service, and the second device is a terminal or a network side device.

Optionally, the first information includes at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

Optionally, the first information includes at least one of the following:
a random phase parameter of at least one antenna port of the first device;
a variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior;
a variation parameter of a random phase parameter of at least one antenna port of the first device relative to a random phase parameter of a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

Optionally, the random phase parameter includes at least one of a random phase value and a random phase value range.

Optionally, the sensing configuration information includes at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal.

Optionally, the sensing apparatus 1400 further includes:
a third sending module, configured to send the first signal to a third device or a reference node, where the third device is a network side device, and the reference node is a reference node that participates in the sensing service or the integrated sensing and communication service.

Optionally, both the first device and the second device are terminals.

The sensing apparatus 1400 further includes:
a fourth sending module, configured to send second information to a fourth device, where the second information is used to assist the fourth device in determining that the first device is a device that sends the first signal, and the fourth device is a network side device.

Optionally, the second information includes at least one of the following:
antenna information of the first device;
status information of the first device;
transmit power information of the first device;
receiving sensitivity information of the first device;
battery level information of the first device; and
computing capability information of the first device.

In conclusion, through the foregoing process, impact exerted by a random phase on sensing performance (or integrated sensing and communication performance) can be resolved, so that the sensing performance can be improved.

The sensing apparatus 1400 in this embodiment of this application may be an electronic device, for example, an electronic device with an operating system, or may be a component such as an integrated circuit or a chip in the electronic device. The electronic device may be a terminal, or may be another device other than the terminal. For example, the terminal may include but is not limited to the foregoing listed types of the terminal 11. The another device may be a server, a network attached storage (NAS), or the like. This is not specifically limited in this embodiment of this application.

The sensing apparatus 1400 provided in this embodiment of this application can implement processes implemented in the method embodiment of FIG. 3, and achieve a same technical effect. To avoid repetition, details are not described herein again.

As shown in FIG. 15, an embodiment of this application further provides a sensing apparatus. The sensing apparatus may be applied to a second device, and the second device is a terminal or a network side device. As shown in FIG. 15, the sensing apparatus 1500 includes:
a first receiving module 1501, configured to receive first information, where the first information is random phase-related information of a first device, and the first device is a terminal;
a first sending module 1502, configured to send sensing configuration information to the first device based on the first information; and
a second receiving module 1503, configured to receive a first signal from the first device, where the first signal is a signal that is determined based on the sensing configuration information and that is related to a sensing service or an integrated sensing and communication service.

Optionally, the first information includes at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

Optionally, the first information includes at least one of the following:
a random phase parameter of at least one antenna port of the first device;
a variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior;
a variation parameter of a random phase parameter of at least one antenna port of the first device relative to a random phase parameter of a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

Optionally, the random phase parameter includes at least one of a random phase value and a random phase value range.

Optionally, the sensing configuration information includes at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal.

Optionally, the sensing apparatus 1500 further includes:
a first determining module, configured to determine a random phase measurement value based on the first signal; and
a second determining module, configured to determine a sensing measurement quantity measurement value based on the first signal and the random phase measurement value.

Optionally, the sensing apparatus 1500 further includes:
a third determining module, configured to determine a random phase calibration parameter or a random phase calibration manner based on the first signal; and
a fourth determining module, configured to determine the sensing measurement quantity measurement value based on the random phase calibration parameter or the random phase calibration manner and the first signal; where
the random phase calibration parameter includes a reference path parameter measurement value; and
the random phase calibration manner includes at least one of a channel state information CSI quotient operation and a CSI conjugate product operation.

Optionally, the sensing apparatus 1500 further includes:
a second sending module, configured to send the sensing configuration information to a third device, where the third device is a network side device;
a third receiving module, configured to receive third information from the third device, where the third information includes a random phase measurement value, and the random phase measurement value is determined based on the sensing configuration information and the first signal; and
a fifth determining module, configured to determine a sensing measurement quantity measurement value based on the first signal and the random phase measurement value.

Optionally, both the first device and the second device are terminals.

The sensing apparatus 1500 further includes:
a third sending module, configured to send fourth information to a fourth device, where the fourth information is used to assist the fourth device in determining that the second device is a device that receives the first signal, and the fourth device is a network side device.

Optionally, the fourth information includes at least one of the following:
antenna information of the second device;
status information of the second device;
transmit power information of the second device;
receiving sensitivity information of the second device;
battery level information of the second device; and
computing capability information of the second device.

Optionally, the sensing apparatus 1500 further includes:
an obtaining module, configured to obtain fifth information, where the fifth information is communication-related information of the first device.

The first sending module 1502 is specifically configured to:
send the sensing configuration information to the first device based on the first information and the fifth information.

Optionally, the fifth information includes:
channel state information between the first device and the second device;
cascaded channel state information between the first device and a reference node, where the reference node is a reference node that participates in the sensing service or the integrated sensing and communication service;
cascaded channel state information between the second device and the reference node;
communication parameter configuration information between the first device and the second device;
channel state information between the first device and a network side device;
channel state information between the second device and the network side device;
communication parameter configuration information between the first device and the network side device; and
communication parameter configuration information between the second device and the network side device.

Optionally, in a case that a sensing target is an active target, the fifth information further includes at least one of the following:
channel state information between the second device and the sensing target;
channel coherence time between the second device and the sensing target;
channel state information between the first device and the sensing target; and
channel coherence time between the first device and the sensing target.

In conclusion, through the foregoing process, impact exerted by a random phase on sensing performance (or integrated sensing and communication performance) can be resolved, so that the sensing performance can be improved.

The sensing apparatus 1500 in this embodiment of this application may be an electronic device, for example, an electronic device with an operating system, or may be a component such as an integrated circuit or a chip in the electronic device. The electronic device may be a terminal, or may be another device other than the terminal. For example, the terminal may include but is not limited to the foregoing listed types of the terminal 11. The another device may be a server, a NAS, or the like. This is not specifically limited in this embodiment of this application.

The sensing apparatus 1500 provided in this embodiment of this application can implement processes implemented in the method embodiment of FIG. 4, and achieve a same technical effect. To avoid repetition, details are not described herein again.

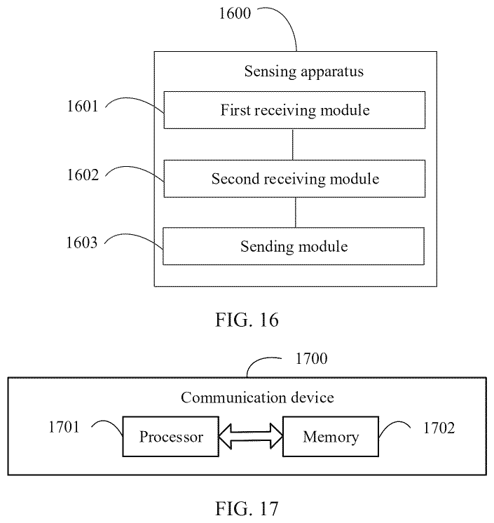

As shown in FIG. 16, an embodiment of this application further provides a sensing apparatus. The sensing apparatus may be applied to a third device, and the third device is a network side device. As shown in FIG. 16, a sensing apparatus 1600 includes:
a first receiving module 1601, configured to receive sensing configuration information from a second device, where the sensing configuration information is determined based on random phase-related information of a first device, the first device is a terminal, and the second device is another terminal;
a second receiving module 1602, configured to receive at least one of a first signal and a second signal, where the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service; and
a sending module 1603, configured to send third information to the second device based on the sensing configuration information and the at least one of the first signal and the second signal, where the third information includes a random phase measurement value.

In conclusion, through the foregoing process, impact exerted by a random phase on sensing performance (or integrated sensing and communication performance) can be resolved, so that the sensing performance can be improved.

The sensing apparatus 1600 in this embodiment of this application may be an electronic device, for example, an electronic device with an operating system, or may be a component such as an integrated circuit or a chip in the electronic device. The electronic device may be a terminal, or may be another device other than the terminal. For example, the terminal may include but is not limited to the foregoing listed types of the terminal 11. The another device may be a server, a NAS, or the like. This is not specifically limited in this embodiment of this application.

The sensing apparatus 1600 provided in this embodiment of this application can implement processes implemented in the method embodiment of FIG. 11, and achieve a same technical effect. To avoid repetition, details are not described herein again.

Optionally, as shown in FIG. 17, an embodiment of this application further provides a communication device 1700, including a processor 1701 and a memory 1702. The memory 1702 stores a program or instructions capable of running on the processor 1701. For example, when the communication device 1700 is a terminal, the program or the instructions are executed by the processor 1701 to implement the steps in the foregoing embodiment of the sensing method, and a same technical effect can be achieved. When the communication device 1700 is a network side device, the program or the instructions are executed by the processor 1701 to implement the steps in the foregoing embodiments of the sensing method, and a same technical effect can be achieved. To avoid repetition, details are not described herein again.

An embodiment of this application further includes a first device. The first device is a terminal, and the first device includes a processor and a communication interface. The communication interface is configured to: send first information, where the first information is random phase-related information of the first device; receive sensing configuration information, where the sensing configuration information is determined based on the first information; and send a first signal to a second device based on the sensing configuration information, where the first signal is a signal related to a sensing service or an integrated sensing and communication service, and the second device is a terminal or a network side device.

An embodiment of this application provides a second device. The second device is a terminal or a network side device, and the second device includes a processor and a communication interface. The communication interface is configured to: receive first information, where the first information is random phase-related information of a first device, and the first device is a terminal; send sensing configuration information to the first device based on the first information; and receive a first signal from the first device, where the first signal is a signal that is determined based on the sensing configuration information and that is related to a sensing service or an integrated sensing and communication service.

An embodiment of this application further provides a third device. The third device is a network side device, and the third device includes a processor and a communication interface. The communication interface is configured to: receive sensing configuration information from a second device, where the sensing configuration information is determined based on random phase-related information of a first device, the first device is a terminal, and the second device is another terminal; receive at least one of a first signal and a second signal, where the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service; and send third information to the second device based on the sensing configuration information and the at least one of the first signal and the second signal, where the third information includes a random phase measurement value.

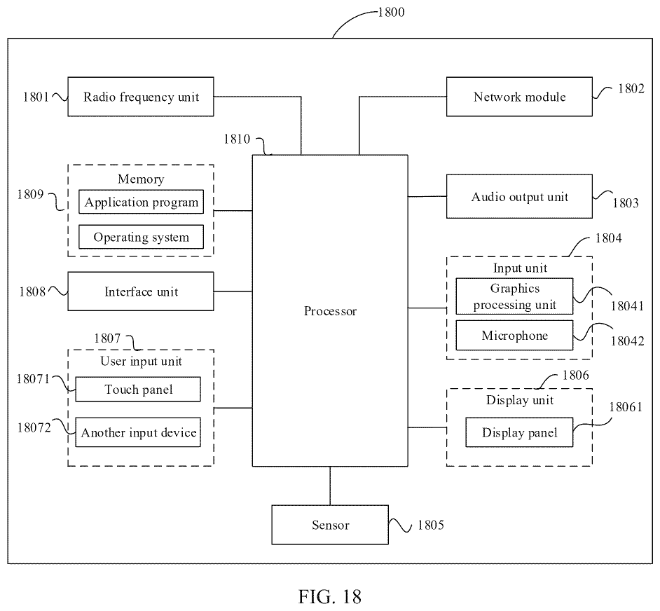

Each implementation process and implementation of the foregoing method embodiment may be applicable to a terminal, and a same technical effect can be achieved. Specifically, FIG. 18 is a schematic diagram of a hardware structure of a terminal for implementing an embodiment of this application.

The terminal 1800 includes but is not limited to at least some of the following components: a radio frequency unit 1801, a network module 1802, an audio output unit 1803, an input unit 1804, a sensor 1805, a display unit 1806, a user input unit 1807, an interface unit 1808, a memory 1809, a processor 1810, and the like.

A person skilled in the art may understand that the terminal 1800 may further include a power supply (for example, a battery) that supplies power to each component. The power supply may be logically connected to the processor 1810 by using a power management system, to implement functions such as charging management, discharging management, and power consumption management through the power management system. The structure of the terminal shown in FIG. 18 does not constitute a limitation on the terminal. The terminal may include more or fewer components than those shown in the figure, or combine some components, or have different component arrangements. Details are not described herein again.

It should be understood that in this embodiment of this application, the input unit 1804 may include a graphics processing unit (GPU) 18041 and a microphone 18042, and the graphics processing unit 18041 processes image data of a still picture or a video obtained by an image capture apparatus (for example, a camera) in a video capture mode or an image capture mode. The display unit 1806 may include a display panel 18061, and the display panel 18061 may be configured in a form of a liquid crystal display, an organic light-emitting diode, or the like. The user input unit 1807 includes at least one of a touch panel 180181 and another input device 18072. The touch panel 180181 is also referred to as a touchscreen. The touch panel 180181 may include two parts: a touch detection apparatus and a touch controller. The another input device 18072 may include but is not limited to a physical keyboard, a function key (such as a volume control key or an on/off key), a trackball, a mouse, and an operating lever. Details are not described herein again.

In this embodiment of this application, after receiving downlink data from a network side device, the radio frequency unit 1801 may transmit the downlink data to the processor 1810 for processing. In addition, the radio frequency unit 1801 may send uplink data to the network side device. Generally, the radio frequency unit 1801 includes but is not limited to an antenna, an amplifier, a transceiver, a coupler, a low-noise amplifier, a duplexer, and the like.

The memory 1809 may be configured to store a software program or instructions and various types of data. The memory 1809 may mainly include a first storage area for storing a program or instructions and a second storage area for storing data. The first storage area may store an operating system, an application program or instructions required by at least one function (for example, a sound play function or an image play function), and the like. In addition, the memory 1809 may include a volatile memory or a non-volatile memory, or the memory 1809 may include both a volatile memory and a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1809 in this embodiment of this application includes but is not limited to these memories and any other suitable type of memory.

The processor 1810 may include one or more processing units. Optionally, the processor 1810 integrates an application processor and a modem processor. The application processor mainly processes operations related to an operating system, a user interface, an application program, and the like. The modem processor mainly processes a wireless communication signal, such as a baseband processor. It may be understood that, the foregoing modem processor may not be integrated into the processor 1810.

The terminal 1800 may be used as a first device to perform steps of the sensing method in the embodiments of this application, or may be used as a second device to perform steps of the sensing method in the embodiments of this application.

In one aspect, the terminal 1800 may be used as the first device to perform the following steps:

The radio frequency unit 1801 is configured to:
send first information, where the first information is random phase-related information of the first device;
receive sensing configuration information, where the sensing configuration information is determined based on the first information; and
send a first signal to a second device based on the sensing configuration information, where the first signal is a signal related to a sensing service or an integrated sensing and communication service, and the second device is a terminal or a network side device.

Optionally, the first information includes at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

Optionally, the first information includes at least one of the following:
a random phase parameter of at least one antenna port of the first device;
a variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior;
a variation parameter of a random phase parameter of at least one antenna port of the first device relative to a random phase parameter of a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

Optionally, the random phase parameter includes at least one of a random phase value and a random phase value range.

Optionally, the sensing configuration information includes at least one of the following: antenna port configuration information, used to indicate an antenna port used by the first device to send the first signal;
time domain sensing information, used to indicate a time domain resource used by the first device to send the first signal; and
power configuration information, used to indicate power at which the first device sends the first signal.

Optionally, the radio frequency unit 1801 is further configured to:
send the first signal to a third device or a reference node, where the third device is a network side device, and the reference node is a reference node that participates in the sensing service or the integrated sensing and communication service.

Optionally, both the first device and the second device are terminals.

The radio frequency unit 1801 is further configured to:
send second information to a fourth device, where the second information is used to assist the fourth device in determining that the first device is a device that sends the first signal, and the fourth device is a network side device.

Optionally, the second information includes at least one of the following:
antenna information of the first device;
status information of the first device;
transmit power information of the first device;
receiving sensitivity information of the first device;
battery level information of the first device; and
computing capability information of the first device.

In another aspect, the terminal 1800 may be used as a second device to perform the following steps:

The radio frequency unit 1801 is configured to:
receive first information, where the first information is random phase-related information of a first device, and the first device is a terminal;
send sensing configuration information to the first device based on the first information; and
receive a first signal from the first device, where the first signal is a signal that is determined based on the sensing configuration information and that is related to a sensing service or an integrated sensing and communication service.

Optionally, the first information includes at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

Optionally, the first information includes at least one of the following:
a random phase parameter of at least one antenna port of the first device;
a variation parameter of a first random phase parameter of at least one antenna port of the first device relative to a second random phase parameter, where the first random phase parameter is a random phase parameter at the time when the first device performs first sending behavior, and the second random phase parameter is a random phase parameter at the time when the second device performs second sending behavior;
a variation parameter of a random phase parameter of at least one antenna port of the first device relative to a random phase parameter of a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

Optionally, the random phase parameter includes at least one of a random phase value and a random phase value range.

Optionally, the sensing configuration information includes at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal.

Optionally, the processor 1810 is configured to:
determine a random phase measurement value based on the first signal; and
determine a sensing measurement quantity measurement value based on the first signal and the random phase measurement value.

Optionally, the processor 1810 is further configured to:
determine a random phase calibration parameter or a random phase calibration manner based on the first signal; and
determine a sensing measurement quantity measurement value based on the random phase calibration parameter or the random phase calibration manner and the first signal; where the random phase calibration parameter includes a reference path parameter measurement value; and
the random phase calibration manner includes at least one of a channel state information CSI quotient operation and a CSI conjugate product operation.

Optionally, the radio frequency unit 1801 is further configured to:
send the sensing configuration information to a third device, where the third device is a network side device;
receive third information from the third device, where the third information includes a random phase measurement value, and the random phase measurement value is determined based on the sensing configuration information and the first signal.

The processor 1810 is configured to:
determine a sensing measurement quantity measurement value based on the first signal and the random phase measurement value.

Optionally, both the first device and the second device are terminals.

The radio frequency unit 1801 is further configured to:
send fourth information to a fourth device, where the fourth information is used to assist the fourth device in determining that the second device is a device that receives the first signal, and the fourth device is a network side device.

Optionally, the fourth information includes at least one of the following:
antenna information of the second device;
status information of the second device;
transmit power information of the second device;
receiving sensitivity information of the second device;
battery level information of the second device; and
computing capability information of the second device.

Optionally, the radio frequency unit 1801 is further configured to:
obtain fifth information, where the fifth information is communication-related information of the first device; and
send the sensing configuration information to the first device based on the first information and the fifth information.

Optionally, the fifth information includes:
channel state information between the first device and the second device;
cascaded channel state information between the first device and a reference node, where the reference node is a reference node that participates in the sensing service or the integrated sensing and communication service;
cascaded channel state information between the second device and the reference node;
communication parameter configuration information between the first device and the second device;
channel state information between the first device and a network side device;
channel state information between the second device and the network side device;
communication parameter configuration information between the first device and the network side device; and
communication parameter configuration information between the second device and the network side device.

Optionally, in a case that a sensing target is an active target, the fifth information further includes at least one of the following:
channel state information between the second device and the sensing target;
channel coherence time between the second device and the sensing target;
channel state information between the first device and the sensing target; and
channel coherence time between the first device and the sensing target.

In conclusion, through the foregoing process, impact exerted by a random phase on sensing performance (or integrated sensing and communication performance) can be resolved, so that the sensing performance can be improved.

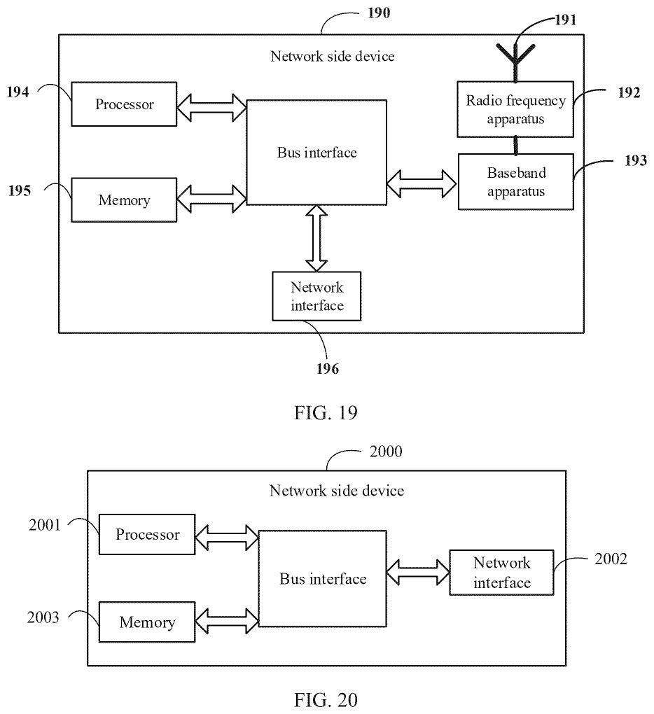

Each implementation process and implementation of the foregoing method embodiment may be applicable to a network side device, and a same technical effect can be achieved. Specifically, FIG. 19 is a schematic diagram of a hardware structure of a network side device according to an embodiment of this application. As shown in FIG. 19, the network side device 190 includes an antenna 191, a radio frequency apparatus 192, a baseband apparatus 193, a processor 194, and a memory 195. The antenna 191 is connected to the radio frequency apparatus 192. In an uplink direction, the radio frequency apparatus 192 receives information through the antenna 191, and sends the received information to the baseband apparatus 193 for processing. In a downlink direction, the baseband apparatus 193 processes to-be-sent information, and sends processed information to the radio frequency apparatus 192. After processing the received information, the radio frequency apparatus 192 sends processed information through the antenna 191.

The method performed by the network side device in the foregoing embodiment may be implemented in the baseband apparatus 193. The baseband apparatus 193 includes a baseband processor.

For example, the baseband apparatus 193 may include at least one baseband board. A plurality of chips are disposed on the baseband board. As shown in FIG. 19, one of the chips is, for example, the baseband processor, and is connected to the memory 195 by using a bus interface, to invoke a program in the memory 195 to perform an operation of a network device shown in the foregoing method embodiment.

The network side device may further include a network interface 196, and the interface is, for example, a common public radio interface (CPRI).

Specifically, the network side device 190 in this embodiment of this application further includes instructions or a program stored in the memory 195 and capable of running on the processor 194. The processor 194 invokes the instructions or the program in the memory 195 to perform the method performed by the modules shown in FIG. 15 or FIG. 16, and a same technical effect is achieved. To avoid repetition, details are not described herein again.

Specifically, an embodiment of this application further provides a network side device. As shown in FIG. 20, the network side device 2000 includes a processor 2001, a network interface 2002, and a memory 2003. The network interface 2002 is, for example, a common public radio interface (CPRI).

Specifically, the network side device 2000 in this embodiment of this application further includes instructions or a program stored in the memory 2003 and capable of running on the processor 2001. The processor 2001 invokes the instructions or the program in the memory 2003 to perform the method performed by the modules shown in FIG. 15 or FIG. 16, and a same technical effect is achieved. To avoid repetition, details are not described herein again.

An embodiment of this application further provides a readable storage medium. The readable storage medium stores a program or instructions. When the program or the instructions are executed by a processor, the processes in the foregoing embodiment of the sensing method are implemented, or the processes in the foregoing embodiment of the sensing method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the foregoing embodiment of the sensing method, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing embodiment of the sensing method, and a same technical effect can be achieved. To avoid repetition, details are not described herein again.

An embodiment of this application further provides a communication system, including a first device and a second device. The first device may be configured to perform the steps of the foregoing sensing method, and the second device may be configured to perform the steps of the foregoing sensing method.

An embodiment of this application further provides a communication system, including a first device, a second device, and a third device. The first device may be configured to perform the steps of the foregoing sensing method, the second device may be configured to perform the steps of the foregoing sensing method, and the third device may be configured to perform the steps of the foregoing sensing method.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the related technologies can be embodied in a form of a computer software product. The computer software product is stored in a storage medium (such as a ROM/RAM, a magnetic disk, or an optical disc), and includes several instructions for enabling a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A sensing method, comprising:
sending, by a first device, first information, wherein the first information is random phase-related information of the first device, and the first device is a terminal;
receiving, by the first device, sensing configuration information, wherein the sensing configuration information is determined based on the first information; and
sending, by the first device, a first signal to a second device based on the sensing configuration information, wherein the first signal is a signal related to a sensing service or an integrated sensing and communication service, and the second device is a terminal or a network side device.

2. The method according to claim 1, wherein the first information comprises at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device;
or,
wherein the sensing configuration information comprises at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal;
or,
wherein the method further comprises:
sending, by the first device, the first signal to a third device or a reference node, wherein the third device is a network side device, and the reference node is a reference node that participates in the sensing service or the integrated sensing and communication service.

3. The method according to claim 1, wherein the first information comprises at least one of the following:
a random phase parameter of at least one antenna port of the first device;
a variation parameter of a first random phase parameter of at least one antenna port of the first device relative to a second random phase parameter, wherein the first random phase parameter is a random phase parameter at the time when the first device performs first sending behavior, and the second random phase parameter is a random phase parameter at the time when the second device performs second sending behavior;
a variation parameter of a random phase parameter of at least one antenna port of the first device relative to a random phase parameter of a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

4. The method according to claim 3, wherein the random phase parameter comprises one of a random phase value and a random phase value range.

5. The method according to claim 1, wherein both the first device and the second device are terminals; and
before the sending, by a first device, first information, the method further comprises:
sending, by the first device, second information to a fourth device, wherein the second information is used to assist the fourth device in determining that the first device is a device that sends the first signal, and the fourth device is a network side device.

6. The method according to claim 5, wherein the second information comprises at least one of the following:
antenna information of the first device;
status information of the first device;
transmit power information of the first device;
receiving sensitivity information of the first device;
battery level information of the first device; and
computing capability information of the first device.

7. A sensing method, comprising:
receiving, by a second device, first information, wherein the first information is random phase-related information of a first device, the first device is a terminal, and the second device is a terminal or a network side device;
sending, by the second device, sensing configuration information to the first device based on the first information; and
receiving, by the second device, a first signal from the first device, wherein the first signal is a signal that is determined based on the sensing configuration information and that is related to a sensing service or an integrated sensing and communication service.

8. The method according to claim 7, wherein the first information comprises at least one of the following:
first indication information, used to indicate random phase information corresponding to at least one antenna port of the first device;
second indication information, used to indicate information about antenna ports with a same random phase in antenna ports of the first device; and
third indication information, used to indicate information about antenna ports with different random phases in the antenna ports of the first device.

9. The method according to claim 7, wherein the first information comprises at least one of the following:
a random phase parameter of at least one antenna port of the first device;
a variation parameter of a first random phase parameter of at least one antenna port of the first device relative to a second random phase parameter, wherein the first random phase parameter is a random phase parameter at the time when the first device performs first sending behavior, and the second random phase parameter is a random phase parameter at the time when the second device performs second sending behavior;
a random phase parameter of at least one antenna port of the first device relative to a preset reference port;
indication information of at least two antenna ports with a same random phase in the antenna ports of the first device;
information about a mapping relationship between a physical antenna and at least two antenna ports with a same random phase in the antenna ports of the first device;
information about a physical antenna to which at least two antenna ports with a same random phase in the antenna ports of the first device are mapped;
port quantity information of at least one group of antenna ports with a same random phase in the antenna ports of the first device;
indication information of whether some or all antenna ports of the first device have a same random phase or different random phases;
antenna switching manner indication information of the first device;
input/output parameter relationship information of a power amplifier of at least one antenna port of the first device; and
antenna polarization manner indication information of the first device.

10. The method according to claim 9, wherein the random phase parameter comprises one of a random phase value and a random phase value range.

11. The method according to claim 7, wherein the sensing configuration information comprises at least one of the following:
antenna port configuration information, used to indicate an antenna port used by the first device to send the first signal;
time domain sensing information, used to indicate a time domain resource used by the first device to send the first signal; and
power configuration information, used to indicate power at which the first device sends the first signal;
or,
wherein after the receiving, by the second device, a first signal from the first device, the method further comprises:
determining, by the second device, a random phase measurement value based on the first signal; and
determining, by the second device, a sensing measurement quantity measurement value based on the first signal and the random phase measurement value;
or,
wherein after the receiving, by the second device, a first signal from the first device, the method further comprises:
determining, by the second device, a random phase calibration parameter or a random phase calibration manner based on the first signal; and
determining, by the second device, a sensing measurement quantity measurement value based on the random phase calibration parameter or the random phase calibration manner and the first signal;
wherein the random phase calibration parameter comprises a reference path parameter measurement value; and
the random phase calibration manner comprises at least one of a channel state information (CSI) quotient operation and a CSI conjugate product operation;
or,
wherein the method further comprises:
sending, by the second device, the sensing configuration information to a third device, wherein the third device is a network side device;
receiving, by the second device, third information from the third device, wherein the third information comprises a random phase measurement value, and the random phase measurement value is determined based on the sensing configuration information and the first signal; and
determining, by the second device, a sensing measurement quantity measurement value based on the first signal and the random phase measurement value.

12. The method according to claim 7, wherein both the first device and the second device are terminals; and
before the receiving, by a second device, first information, the method further comprises:
sending, by the second device, fourth information to a fourth device, wherein the fourth information is used to assist the fourth device in determining that the second device is a device that receives the first signal, and the fourth device is a network side device.

13. The method according to claim 12, wherein the fourth information comprises at least one of the following:
antenna information of the second device;
status information of the second device;
transmit power information of the second device;
receiving sensitivity information of the second device;
battery level information of the second device; and
computing capability information of the second device.

14. The method according to claim 7, further comprising:
obtaining, by the second device, fifth information, wherein the fifth information is communication-related information of the first device; and
the sending, by the second device, sensing configuration information to the first device based on the first information comprises:
sending, by the second device, the sensing configuration information to the first device based on the first information and the fifth information.

15. The method according to claim 14, wherein the fifth information comprises:
channel state information between the first device and the second device;
cascaded channel state information between the first device and a reference node, wherein the reference node is a reference node that participates in the sensing service or the integrated sensing and communication service;
cascaded channel state information between the second device and the reference node;
communication parameter configuration information between the first device and the second device;
channel state information between the first device and a network side device;
channel state information between the second device and the network side device;
communication parameter configuration information between the first device and the network side device; and
communication parameter configuration information between the second device and the network side device.

16. The method according to claim 15, wherein in a case that a sensing target is an active target, the fifth information further comprises at least one of the following:
channel state information between the second device and the sensing target;
channel coherence time between the second device and the sensing target;
channel state information between the first device and the sensing target; and
channel coherence time between the first device and the sensing target.

17. A sensing method, comprising:
receiving, by a third device, sensing configuration information from a second device, wherein the sensing configuration information is determined based on random phase-related information of a first device, the first device is a terminal, the second device is another terminal, and the third device is a network side device;
receiving, by the third device, at least one of a first signal and a second signal, wherein the first signal is a signal that is from the first device and that is related to a sensing service or an integrated sensing and communication service, the second signal is a signal reflected by a reference node after receiving the first signal, and the reference node is a reference node that participates in the sensing service or the integrated sensing and communication service; and
sending, by the third device, third information to the second device based on the sensing configuration information and the at least one of the first signal and the second signal, wherein the third information comprises a random phase measurement value.

18. A communication device, comprising a processor and a memory, wherein the memory stores a program or instructions capable of running on the processor, and the program or the instructions are executed by the processor to implement the steps of the sensing method according to claim 1.

19. A communication device, comprising a processor and a memory, wherein the memory stores a program or instructions capable of running on the processor, and the program or the instructions are executed by the processor to implement the steps of the sensing method according to claim 7.

20. A communication device, comprising a processor and a memory, wherein the memory stores a program or instructions capable of running on the processor, and the program or the instructions are executed by the processor to implement the steps of the sensing method according to claim 17.
